(19) United States
(12) Patent Application Publication
(10) Pub. No.: US 2021/0038469 A1
(43) Pub. Date: Feb. 11, 2021

(54) Direct Stimulation Device with Improved Drive

(71) Applicant: NOVOLUTO GmbH, Berlin (DE)

(72) Inventors: Mark Tobias Zegenhagen, Berlin (DE); Michael Lenke, Berlin (DE)

(21) Appl. No.: 17/044,501

(22) PCT Filed: Apr. 4, 2019
(86) PCT No.: PCT/DE2019/100308

§ 371 Date: Oct. 1, 2020

(30) Foreign Application Priority Data
Apr. 4, 2018 (DE) 10 2018 107 939.7

(51) Int. Cl. A61H 19/00; A61H 23/02

(52) U.S. Cl. CPC A61H 19/34; A61H 19/44; A61H 23/0218; A61H 2201/123; A61H 2201/5058; A61H 2201/5005; A61H 2201/0207; A61H 2201/0165; A61H 2201/5064; A61H 2201/0153; A61H 2201/0111

(57) ABSTRACT

Direct stimulation devices with improved drives are disclosed herein. An example stimulation device for a clitoris includes a stimulation head to contact the clitoris; a linear drive device coupled to the stimulation head and configured to cause the stimulation head to vibrate; a control device configured to control the drive device; a battery to supply power to the control device; and a housing. The control device and the battery are disposed in the housing.

### RELATED APPLICATIONS

This patent claims the benefit under 35 U.S.C. § 371 of International Patent Application Serial No. PCT/DE2019/100308, filed Apr. 4, 2019, which claims priority to German Patent Application No. 10 2018 107 939.7, filed on Apr. 4, 2018. Priority to International Patent Application Serial No. PCT/DE2019/100308 and German Patent Application No. 10 2018 107 939.7 is hereby claimed. International Patent Application Serial No. PCT/DE2019/100308 and German Patent Application No. 10 2018 107 939.7 are hereby incorporated by reference in their entireties.

### FIELD OF THE DISCLOSURE

The invention relates to a stimulation device, in particular for the clitoris, a system comprising such a stimulation device, and a method for stimulating the clitoris.

### BACKGROUND

The erogenous zones of the human body can be stimulated using a variety of aids. For example, vibrators are used to exert a stimulus on a specific area of skin by means of direct contact.

In particular, the direct stimulation of the clitoris, for example with a vibrator, is problematic. In women, the clitoris is usually the most sensitive erogenous zone. The entire clitoris is densely equipped with nerve endings, making it particularly sensitive to touch and sexual stimuli. Here, the clitoral glans, where the nerve endings of both thighs meet, is particularly noteworthy. Thus, on the one hand, frequent use of a vibrator for direct stimulation leads to habituation effects or to conditioning of the stimulated erogenous zone, while, on the other hand, the first-time use of such a device requires a certain amount of practice or familiarization.

Furthermore, medical studies conducted in 2006 determined the female clitoris as the decisive starting point of the female climax and, for the first time, neurologically proved the different sensory qualities of clitoral (and vaginal) orgasm. Thus, according to more recent medical research, stimulation of the clitoris, and not the vagina, is considered to be the starting point for female sexual arousal and thus the key to female “sexual pleasure”.

Furthermore, the sensitivity of the human erogenous zones, for example the clitoris, the inner and outer labia or the nipples, varies greatly from one individual to another. A person can be so sensitive that direct stimulation is only possible after a long period of foreplay, and, even then, only very gently, or not at all. Furthermore, the sensitivity of the corresponding zone can vary greatly from situation to situation or even during a sexual act.

Such a conventional vibrator is known, for example, under the brand name “Magic Wand”®, and was introduced in the 1960s. This massage wand is also used for clitoral stimulation. It is about 30 cm long and weighs about 540 g. Furthermore, the “Magic Wand”® is powered by a power cable and has no batteries. It also has a spherical stimulation head with a diameter of approximately 6-7 cm. Furthermore, this massage wand has an electric motor which drives a rotatably mounted weight in the stimulation head with an eccentric weight distribution, i.e. with an unbalance of a working mass, via a flexible shaft. For this purpose, two speed levels, approximately 5,000 or 6,000 revolutions per minute, can be selected for the electric motor, which results in vibrations of the stimulation head with a corresponding frequency of approximately 83 Hz or approximately 100 Hz. The total amplitude of the vibrations or the stroke of the stimulation head is about 0.45 mm, and the unbalanced excited deflection of the stimulation head is perpendicular to the longitudinal axis of the massage wand. Thus, this massage wand vibrates with a single preset vibration frequency with a constant vibration amplitude with a circular movement of the stimulation head. More specifically, the stimulation head vibrates with the excitation circuit frequency of the unbalance, and thus proportionally to the speed of the driving electric motor.

This massage wand has a fairly strong massaging effect that sexually stimulates the clitoris and that, according to a publication in the Scientific World Journal “Struck, Pia; Søren Ventegodt (2008). “Research Article: Clinical Holistic Medicine: Teaching Orgasm for Females with Chronic Anorgasmia using the Betty Dodson Method”, The Scientific World Journal, Hindawi Publishing Corporation, Volume 8, 883-895”, could lead to sexual climax in approximately 93% of women in a given test group.

Disadvantages of this massage wand are its weight, its size, its design and the clumsy use of the wand resulting from the above. Likewise, the massage wand tends to overheat during continuous operation over a period of 20 to 30 minutes. A further disadvantage is that users report strong habituation effects in some cases, it being stated that even the general sensitivity or sensitivity to stimuli of the clitoris may be permanently reduced. Accordingly, the above medical publication of the Scientific World Journal also reports temporary pain in the vulva due to the physical stimulation by the massage wand used (see loc. cit., p. 888, above), which is why a dulling or habituation effect can be assumed with repeated use. Clitoral pain is also, naturally, undesirable. Further disadvantages of this massage wand are the operating noise, which can be perceived as disturbing, and a lack of hygiene of the device, as it is not easy to clean. Also, this wand is not waterproof, which means that it cannot be used in the bathtub, for example.

In addition, an unbalanced excited deflection of the stimulation head results in increased undesired natural vibrations of the entire device, which are just as noticeable and disturbing due to the usually large moving working mass of the driven weight. These natural vibrations of the prior-art equipment have a multitude of vibration directions, which usually lie in the plane in which the weight is eccentrically rotated. Consequently, a grip of such a device, for example, also vibrates noticeably in different directions. Furthermore, these vibrations are transmitted to the body of the person guiding the device, especially to the hand and arm, which is undesirable.

In order to damp these unwanted vibrations at least slightly, a counterweight or damping mass is now regularly provided, for example a metal block is provided in the grip of the device with a weight of more than 100 grams, with the resulting distribution of the mass being used to reduce vibrations. However, this makes the device heavier and more unwieldy, and the natural vibrations, nevertheless, cannot be completely avoided. In addition, the transmission of vibrations to the body can be somewhat damped by attaching rubber elements; however, this results in high loads on the drive motor, regardless of its design.

Another, more recent vibrator is described in greater detail, for example, in WO 2012 152297 A1. This device for sexual stimulation features a massage wand that can be moved axially back and forth and is connected to a rotary drive device via a transmission device. To convert a rotary movement into a linear stroke movement, the transmission device has at least one traction means, such as a chain or belt, which circulates via deflection elements and is in driving connection with the rotary drive device. A driver is arranged on the traction means and is connected to the massage wand or to an abutment point. Thus, even with this prior-art device, the vibration amplitude is fixed, while the generated vibration has only a single frequency, i.e. it is monofrequent. In addition, this device has only a limited frequency range.

The device of the WO 2012 152297A1 is designed as a hand-held device, in which the massage wand is arranged on a handgrip, although this hand-held device still appears quite large and unwieldy. The massage wand also has an inner cavity, in which the above-mentioned transmission device is integrated, which is disadvantageously mechanically complex.

Other disadvantages of this device are similar to the disadvantages of the “Magic Wand”® described above, especially with regard to hygiene and habituation effects. For example, the vibrator of the WO 2012 152297A1 V produces a strong vibration, which has a disadvantageous effect of encouraging habituation to this vibration. The operating noise is also loud, among other things due to the mechanics used.

Even today (after more than 50 years) the principle of the “Magic Wand”® is still regarded as groundbreaking for the touching or direct stimulation of the clitoris. There are many further developments of this massage wand, one of which is listed above as an example. What these devices have in common is that they have an electric motor with unbalance for generating vibrations.

### SUMMARY

In view of the problems set out above, it is an object of the invention to provide a stimulation device for the clitoris which does not have the disadvantages set out above.

Furthermore, it may be an object of the present invention to provide a stimulation device for the clitoris which produces a more interesting or varied stimulation sensation and/or which provides a new type of touching stimulation of the clitoris.

Also, the stimulation device for the clitoris according to the invention should preferably be more compact, smaller, lighter and more comfortable, and/or should not have any habituation effects, and/or should also be easier to clean.

The object is achieved by a stimulation device according to claim 1 and by the method according to the further independent claim. Advantageous further developments and embodiments are the subject of the further independent and dependent claims.

Exemplary embodiments are presented below.

A stimulation device for the clitoris is provided in accordance with an embodiment, comprising: a stimulation head for placing on the clitoris; a linear drive device which is coupled to the stimulation head and which can make the stimulation head vibrate; a control device which can control the drive device; a battery for supplying power to the control device; and a housing which comprises the control device and the battery.

One of the inventor's initial findings was that the conventional use of an electric motor with unbalance according to the devices of the prior art greatly limits the dynamics, bandwidth and/or variability of vibration generation per se. In contrast, a linear drive device has the advantage that its strokes or deflections can be made with greater dynamics and a wider bandwidth. Thus, the high sensitivity of the clitoris is taken into account, and there are more possibilities for shaping the stimulus to the clitoris. Furthermore, a linear drive has the advantage that it is more targeted, since substantially the only vibrations generated are those whose direction of deflection is envisaged along a straight line.

In addition, the linear drive is advantageous in avoiding a counterweight in the stimulation device according to the invention. The stimulation device according to the invention thus has no counterweight according to a development of the invention.

The linear drive device can be designed free of rotating (single) components, as would be the case for a drive device with an electric motor (and possibly with eccentric and connecting rod). This means that the linear drive device advantageously does not have an electric motor with a rotating axis, which would generate disturbing (operating) noise or disturbing omni-directional natural vibrations. In other words, the linear drive device works without an electric motor. The linear drive device must also not have any rotating components.

The linear drive device may be provided in such a way that the vibrations of the stimulation head are directed in a direction of deflection towards a front end of the stimulation head which is placed on the clitoris. Consequently, advantageous deflections of the stimulation head towards and away from the clitoris are produced, whereby the vibrations are propagated from the clitoral glans towards the interior of the body to bring about effective stimulation there. In contrast, a drive with an imbalance causes vibrations in one plane in all directions, which can be undesirable and inefficient, for example due to disturbing vibrations of the handgrip, as explained in greater detail above.

The linear drive device may be provided in such a way that directions of movement of the vibrations of the stimulation head coincide with the directions of movement of the deflections of the drive device. Such a structure or such a coupling between the drive device and the stimulation head is efficient, especially since direction-changing transmission members for the mechanical movement between the drive device and the stimulation head are omitted.

The linear drive device may further comprise an electromagnetic linear actuator comprising at least one stationary permanent magnet and at least one conductor movably arranged in the magnetic field of the permanent magnet, with the movably arranged conductor being able to be moved in accordance with the control of the control device for generating vibrations. Provided that the magnetic field direction of the permanent magnet and the current direction in the conductor are not parallel or are anti-parallel, the Lorentz force acts on a current-carrying conductor in the magnetic field. This means that the movably arranged conductor, which is coupled directly or also indirectly to the stimulation head, can easily be subjected to a force that depends on the magnitude of the current flow, the flux density of the magnetic field, the length of the conductor in the magnetic field and the orientation of the current flow with respect to the direction of the magnetic field. An advantageous point here is that the movable conductor (compared with the eccentric weights of the prior art) has a low dead weight, whereby the moving mass can be kept low. Thus, disturbing natural vibrations will be significantly reduced. Likewise, a smaller mass can be moved more effectively and with higher dynamics. All in all, the use of the Lorenz force according to the invention results in completely different possibilities for vibration generation than with unbalanced excited stimulation devices. Preferably, the control device of the stimulation device is configured in such a way that it can adjust a control current that flows through the movably arranged conductor. This can be done, for example, by means of an A/D converter and a downstream driver stage, or by means of an electronic current control circuit. The control device may, for example, be hard-wired, or may also comprise a microcontroller with a memory and a program for control.

The movement of the conductor is at least largely linear, i.e. the movement of the conductor is at least largely parallel or along an imaginary straight line. In other words, an at least largely linear translatory working movement is generated. Furthermore, the conductor is, for example, a straight-line metallic wire. This wire can alternatively be arranged meandering within one plane. The conductor can also be in the form of a coil, which for example has more than 5, preferably more than 10 windings.

The stimulation device and in particular the control device can be configured in such a way that an amplitude of vibration of the stimulation head can be adjusted according to an excitation of the drive device by the control device, preferably by means of the control current. Thus, the vibration amplitude of the stimulation device is an adjustable variable which can be set, in particular, independently of the vibration frequency. Such adjustability of the vibration amplitude has the advantage that the dynamics of the stimulation can be made more variable. For example, in contrast to the prior art as explained above, low vibration frequencies (for example 20 Hz) with a large amplitude (for example 5 mm) can be generated.

The stimulation device may be configured in such a way that the amplitude of vibration of the stimulation head and at least one vibration frequency of the stimulation head can be controlled independently of each other. Consequently, two (at least largely) independently adjustable variables are advantageously provided, which further improve the dynamics and variability of the stimulation. The control device can be configured in such a way that it has predefined or pre-stored control patterns which can be selected by the user, for example. These control patterns lead to a corresponding generation of control currents which have a predefined or preset sequence. A simple example of such a control pattern is a sine wave that results in a sinusoidal profile of the control current. If the conductor now moves accordingly, the stimulation head, which is mechanically coupled to the conductor, will also move according to a stimulation pattern. Finally, the user can choose from various stimulation patterns, examples of which will be explained in greater detail later.

The term “stimulation pattern” in the meaning used here refers to the temporal course of the deflection of the stimulation head. Thus, an electrical control pattern of the control device is converted by the drive device into a mechanical stimulation pattern. The stimulation pattern causes a specific stimulation at the clitoris, with the inventors having recognized in experiments that the user can certainly distinguish different stimulation patterns by their stimulation. Thus, the stimulation device can be used to create different stimuli, which can be selected or adjusted according to the user's individual preference. In the case of a preferred variant of the above, a stimulation pattern also has repetitions in the course of the deflections.

The stimulation device may be configured in such a way that multi-frequency vibrations can be generated. Multi-frequency vibrations or also vibrations with at least two frequency components are characterized in that the stimulation head vibrates (simultaneously) with at least two identifiable frequencies. An identification of the frequencies can be carried out, for example, by means of a vibration analysis, which is carried out by means of a vibration analyzer and an associated sensor, for example a piezoelectric force sensor. The vibrations of the stimulation head are measured, the acquired measurement signal is converted by means of a Fast Fourier Transformation (FFT), and then the result of the calculation is evaluated in the form of an FFT frequency spectrum. The FFT frequency spectrum identifies and quantifies the frequency components of the vibrations. A second or further frequency is considered identified if the peak amplitude of one frequency does not deviate by more than 9 dB, preferably not more than 6 dB, from the peak of the strongest frequency in the FFT frequency spectrum.

Experiments have shown that multi-frequency vibrations have a specific stimulation effect. Especially in the case of vibrations of the stimulation head in the form of beats, the user is excited by the basic frequency on the one hand, while on the other hand there is a periodically increasing and decreasing amplitude of the vibrations, thus supplementing the excitation. A beating is the result of the additive superposition of two vibrations which differ only slightly in frequency, the latter having a periodically increasing and decreasing amplitude.

The drive device can be configured to generate the multi-frequency vibrations. In this case, the drive device may be configured to generate vibrations in a frequency range from 40 Hz to 170 Hz, preferably in a frequency range from 20 Hz to 1.1 kHz, and even more preferably in a frequency range from 16 Hz to 15 kHz. Consequently, the vibrations of the stimulation device according to the invention can be generated in a wide frequency range, whereby the stimulation can be carried out advantageously in a very variable manner. The frequency range of the drive device can preferably be determined by means of an FFT frequency spectrum, so that the drive device can generate frequencies in one of the aforementioned frequency ranges which have an amplitude in the FFT frequency spectrum which is no more than 9, preferably 6 dB, lower than the frequency with the highest amplitude in the frequency range. In other words, for example, the 6 dB cut-off frequencies of the drive device are on or outside 40 and 170 Hz. This has shown that stimulation with frequencies between 40 and 170 Hz is perceived particularly effectively. In the larger frequency range of 20 Hz to 1.1 kHz, a basic stimulation with a frequency in the range of 20 Hz to 170 Hz can be performed preferably, and a further frequency component with a higher frequency can be added, which can change the user's impression of the stimulation stimulus. The frequency range of 16 Hz to 15 kHz also corresponds to the most important range, which can be heard by the user in addition. Thus, the vibrations of the stimulation head may preferably have additional audible components, for example a piece of music which adds an audible additional effect to the mechanical stimulation of the clitoris. Thus, the vibrations generated by the stimulation device can be intended for the clitoris and the ears at the same time.

The stimulation device may be provided in such a way that the drive device is configured so that the vibrations of the stimulation head may be amplitude-modulated and/or frequency-modulated. This increases the variability of the device according to the invention. Frequency-modulated vibrations in particular change their stimulation effect on the clitoris during operation of the device, whereby habituation effects are reduced and new stimulation effects can also be achieved. An example of this is a recurring change in the basic frequency of the vibrations of the stimulation head in a frequency range from 60 to 100 Hz and back with a frequency change rate of 1 Hz/s. The advantageous effect of an amplitude modulation of the vibrations has already been explained above as an example with regard to the beat, and therefore no further explanations are necessary.

The stimulation device may be provided in such a way that the drive device comprises a moving coil assembly with a moving coil and a vibrating element. By means of a moving coil assembly with a moving coil, the length of the conductor and also the strength of the effective magnetic field can be increased, whereby the generated Lorentz forces are greater. Thus, a vibration generation can be more effective than with unbalanced excited vibration generation. In addition, this represents a compact and cost-efficient arrangement to be produced.

The drive device may be configured in such a way that an amplitude of vibration of a maximum of 0.1 mm, preferably of a maximum of 0.05 mm, can be generated. Conventional lay-on vibrators have a vibration amplitude of the stimulation head which is considerably larger in order to achieve a stimulation effect sufficient for the user in every case. However, this makes it more difficult to perform gentle stimulation, as the device must now be held manually at a predetermined distance above the clitoris to reduce the effect. This is cumbersome. It is also difficult for a third party using the device on the user to estimate the correct distance. It is also possible that the user may wish to allow the stimulation to last for longer, i.e. the stimulation should start slowly and reach its peak only after some time. For this reason, the present stimulation device, the control device and the drive device are configured in such a way that small vibration amplitudes can be generated, which means that a clitoral stimulation can take place with noticeably less effect, while at the same time the stimulation device can be placed on the clitoris with normal force. For example, the small vibration amplitudes are generated by controlling the drive device with correspondingly small control currents. However, it is also necessary that the motion resistance of the drive device (this motion resistance can be caused, for example, by adhesive forces or the mass inertia of the moving parts) is dimensioned in such a way that even low control currents can lead to corresponding vibrations. In the case of a moving coil assembly, for example, the mass of the moving coil, the vibrating element and the stimulation head must be provided with a corresponding (low) mass. In addition, the elasticity of a possibly provided centering spider and/or a silicone coating should preferably also be sufficiently large so that the vibration amplitudes of a maximum of 0.1 mm, preferably of a maximum of 0.05 mm, can be generated.

The stimulation device can be provided in such a way that the drive device has a, preferably elastic, membrane as suspension for the moving coil, and the moving coil can be moved in a magnetic field of a permanent magnet of the moving coil assembly by feeding a control current from the control device into the moving coil. Such a suspension allows the moving coil to be moved linearly and with a correspondingly high dynamic range.

In addition, the membrane may have such mechanical strength that it will not be damaged even with frequent use and in particular when force is applied outside the alignment axis or under torsion. Thus, during tactile stimulation, use-related loads are more or less directly introduced into the membrane, which means that this membrane and its attachment should have a particular strength. Furthermore, the membrane or a bead of the membrane can be made of nylon or metal, for example. It is particularly preferred that these are at least largely made of silicone or a fluoroelastomer. As silicone material, for example, “Silopren HV3”® from the manufacturer BASF can be used. The material with the brand name “Fluorel”® from the company 3M can be used as a fluoroelastomer, for example.

The stimulation device may be designed in such a way that the stimulation device has at least one stop element to protect the drive device from damage. A linear drive device, in particular a drive device with a moving coil assembly, is a precision mechanical device which may be sensitive to mechanical stress. In particular, the suspension of the moving conductor or moving coil may be damaged if excessive forces are applied to the stimulation head. Such forces may occur, for example, if the stimulation device is dropped and the stimulation head hits the floor. The stop element is an element that limits the maximum deflection of the stimulation head and/or the drive device by means of a mechanical stop, thus preventing overloading of a suspension. Examples of this are given in the embodiments explained later.

The stimulation head can be exchangeably coupled to the vibrating element of the moving coil assembly. An exchangeable stimulation head has the advantages that it is easier to clean as a separate part and that different stimulation heads can be used on the same device depending on the user's preference.

The control device may include a signal generator configured in such a way that substantially rectangular or triangular or sawtooth-shaped vibrations can be generated. These forms of vibration have the advantage over the usual sinusoidal vibration that they create a different type of stimulation of the clitoris. Due to the abrupt change in the direction of movement, these forms of vibration can cause a more intense stimulation, which could be described as “tingling” or “harder”, for example.

The triangular vibrations can be generated in a frequency range from approximately 20 to 170 Hz. Here, the improved frequency range described above is combined with the special signal shape described above, which together can produce a particularly intense stimulation.

The vibrations can be generated in a narrow band over a continuous frequency range of at least 20 Hz, preferably at least 100 Hz. Such vibrations have properties that correspond to narrow-band noise. This noise is characterized by the fact that its amplitude in the FFT frequency spectrum (which is determined as explained above) over a frequency width of at least 20 Hz, preferably at least 100 Hz, does not drop more than 9 dB, preferably not more than 6 dB, below the amplitude maximum value in this frequency range. A mean frequency of such a noise may be at 50 Hz or at 100 Hz, for example. Such noise has a specific stimulating effect, which can be used as foreplay, for example, and avoids habituation effects.

The membrane may be arranged in such a way as to seal the moving coil with respect to the outside of the stimulation device, preferably in a waterproof manner. This prevents the penetration of an undesirable fluid (for example vaginal fluid, dust, or even water) into the moving coil assembly, thus keeping the air gap free from interference. This serves both for hygiene and to maintain the functionality of the drive device.

A sensor device may be configured to detect an approach of the stimulation device towards the clitoris or contact of the stimulation device with the clitoris, and to output an activation signal to the control device when an approach or contact is detected, the control device being configured in such a way that the drive device is activated when an activation signal is present, the sensor device preferably being a capacitive, acoustic or optical proximity switch, which is configured in such a way that an approach of the clitoris towards the stimulation head can be detected.

This means that the stimulation device advantageously is only activated when the clitoris is close to the stimulation head. This is advantageous in terms of saving battery power, as the stimulation device is not continuously operated after being switched on, as is in the prior art, but only when it is possible to have an effect on the clitoris. This shortens the time in which the stimulation device is in operation. In addition, the overall noise level of the stimulation device perceptible to the user is advantageously reduced, since the device with its stimulation head is directed towards the clitoris when the vibrations are generated and therefore only a damped operation takes place.

The sensor device may be a capacitive, acoustic or optical sensor, preferably a proximity switch, which is configured in such a way that an approach of the clitoris in front of the stimulation head can be detected. This has the advantage that a defined measuring range can be provided within which the presence or absence of the clitoris can be reliably detected.

An acoustic sensor or preferably an acoustic proximity switch can, for example, operate according to the known ultrasonic transit time measurement principle. An optical sensor or preferably an optical proximity switch can, for example, operate according to the known infrared measurement principles. A capacitive sensor can operate according to the known capacitive measurement principles.

More specifically, a capacitive sensor measures a change in capacitance at a measuring electrode, a capacitance at the measuring electrode or the change in capacitance and at the same time the capacitance at the measuring electrode. From this, a measurement signal is generated which is representative of the distance of a surface from the measurement electrode. Preferably, with the aforementioned principles, an activation signal can be generated by comparing the measured values with a threshold value which indicates whether or not the clitoris has approached the stimulation device beyond a predetermined distance.

For example, a capacitive sensor may have at least one measuring electrode. The capacitance at the measuring electrode depends on how far away an area is from the measuring electrode or whether an area is placed on the measuring electrode. For example, a surface can be a surface of an object, such as the surface of the clitoris. The surface of the clitoris and the surface of the measuring electrode can be regarded, in essence, as two opposite surfaces of a capacitor. The capacitance of this capacitor depends on various factors, especially the distance between these surfaces. The capacitive sensor can be set to transmit the activation signal to the control device when, for example, a predetermined threshold of capacitance and/or change in capacitance is exceeded or undershot.

The capacitive sensor may also have a control logic (preferably adjustable or programmable) that generates or calculates the activation signal from a measured value obtained from the measuring electrode. A reference measuring electrode may also be provided to improve the measurement accuracy. The differential measurement performed in this way can be used, for example, to compensate for fluctuations in ambient conditions (temperature, humidity, etc.) that affect capacitance. Furthermore, a shielding electrode can be provided to avoid interference effects. Such shielding can be used to reduce parasitic capacitances or to improve the directivity of the capacitive measurement.

In one embodiment of the capacitive sensor, a plurality of measuring electrodes, for example two measuring electrodes, of the capacitive sensor can be provided, and the capacitive sensor can be configured in such a way that it only emits the activation signal if a change in capacitance and/or capacitance which is above a predetermined threshold value is measured at both measuring electrodes simultaneously. This improves the reliability of the sensor device.

Furthermore, the sensor device can alternatively be configured as a UWB sensor unit. In this context, a “UWB sensor unit” (UWB=ultra wide band) is to be understood in particular to mean a sensor unit which is intended to transmit and/or receive electromagnetic signals with a mean frequency between 30 MHz and 15 GHz and a bandwidth of at least 500 MHz, typically of a few GHz. By designing the sensor device as a UWB sensor unit, a particularly high information content can advantageously be obtained with respect to the characterizing physical measurement parameters of the body. In this way, it is possible to differentiate between a human body and an object, for example. Preferably, the spectral power density of the UWB sensor unit is a maximum of −41.3 dBm/Hz EIRP (Equivalent Isotropic Radiated Power), so that interference with other devices operated at frequencies between 30 MHz and 15 GHz can be advantageously avoided.

In this context, it may be provided that the UWB sensor unit is configured to operate at a mean frequency that varies discretely within a given frequency range. In contrast to a wideband excitation of the frequency range, the UWB sensor unit is excited discretely in the form of a pulse-like excitation of the UWB sensor unit, with the mean frequency successively assuming different discrete values in the predetermined frequency range. Preferably, frequency intervals between two successive excitation frequencies take on different values in order to comply with the stipulations of regulatory authorities in a particularly effective way. In this context, a “mean frequency” of the UWB sensor unit is to be understood in particular to mean a frequency that represents an arithmetic mean of two frequencies at which a spectral power density, relative to a maximum spectral power density of the UWB sensor system, has decreased by about 6 dB, preferably 10 dB. By varying the mean frequency of the UWB sensor unit, the information content with respect to the characterizing physical size or proximity of the clitoris can be increased by measurements in different frequency ranges, making the sensor unit more reliable.

In one embodiment, the UWB sensor unit is intended to operate at a mean frequency that varies periodically within a given frequency range. Here, the frequency range can be scanned by a continuous variation of the mean frequency. However, it is advantageous if the UWB sensor unit is excited at discrete values of the mean frequency in an excitation sequence starting from a lower limit of the frequency range, the mean frequency being increased in steps until an upper limit of the frequency range is reached and this excitation sequence repeating periodically.

It is further suggested that the sensor device has a coplanar antenna. In this context, a “coplanar antenna” is to be understood in particular to mean an antenna formed by strip conductor elements known per se, which are arranged in a plane on a dielectric support. Preferably, the coplanar antenna can be configured as a patch antenna or spiral antenna. In principle, however, the use of other designs which appear to be expedient to a person skilled in the art is also conceivable. Such an antenna can be advantageously and easily mounted inside the housing near the stimulation head. By equipping the sensor device with a coplanar antenna, it is also advantageous to concentrate a sensitivity range of the sensor device on a certain measuring range in front of the stimulation head. Furthermore, such a coplanar antenna can also be ring-shaped and can be arranged, for example, around the moving coil assembly according to the invention. Furthermore, such a coplanar antenna can also be used as a measuring electrode in a capacitive sensor.

The sensor device can be configured to generate and detect an electromagnetic (or acoustic) field, this field being provided in the vicinity of the stimulation head and preferably in front of the stimulation head, as was further explained above. Such a sensor system is inexpensive and reliable in operation.

In this case, this field (and thus the sensor device) can be configured in such a way that a measuring range or a measuring window is provided in front of the stimulation head on an alignment axis of the vibration of the stimulation head (such a measuring window is shown, for example, in FIG. 3 with the reference sign 781).

The sensor device or unit may be configured to detect, alternatively or in addition to the above, contact between a wall forming part of the stimulation head and the skin of the clitoris. This can be done, for example, by measuring the conductivity between two electrodes provided in the wall. Such a sensor can also be realized with a capacitive measuring principle, especially if the measuring range is set to be very small. This has the advantage that, with a simple solution, contact of the body with the stimulation device can be detected in such a way that mere contact of the skin with the wall leads to an activation of the drive device. This in turn saves battery life and leads to noise reduction.

The housing and the moving coil assembly can be configured to be waterproof so that the stimulation device can be used under water. Such a design has the advantage that the device can also be used under water, for example in the bathtub, and that it is easier to clean.

The control device may include a random generator capable of generating a substantially random stimulation pattern, with which the drive device may be driven by the control device in such a way that the vibrations of the stimulation head provide corresponding random stimulation patterns. This results in stimulation of the clitoris in a manner not predictable for the user, which increases the reuse value of the device. In addition, familiarization effects are avoided. A random generator according to the invention can, for example, be part of a program of the control device, which generates the patterns “pseudo”-randomly. The random generator can also be hard-wired, for example, and can be obtained as a one-chip solution from various manufacturers.

The control device may have at least one predefined control pattern with which the drive device can be driven by the control device in such a way that the vibrations of the stimulation head provide at least one corresponding predefined stimulation pattern. Such a control pattern can be present, for example, in the form of digital data, for example as a file in a common audio format such as MP3 or WAV (waveform file format). Thus, the control patterns can also be available as PCM raw data, i.e. a discrete representation of the time and value of the temporal profile of the signal of the control pattern. A suitable control pattern can also be generated by means of a signal generator which, for example, generates a square wave signal shape with a user-selectable frequency and a predefined amplitude. In another case, the control pattern can have a sinusoidal shape of which the frequency or frequencies are predefined in the stimulation device.

The stimulation device may have an extension in the form of a dildo for insertion into the vagina, the stimulation device preferably being configured such that the extension can be inserted into the vagina while at the same time the stimulation head can rest on the clitoris. Thus, (at least) one extension can be provided in the stimulation device in accordance with the invention. On the one hand, this extension can be used as a handgrip to hold the stimulation device easily and comfortably, and, on the other hand, the extension can also be used as a direct or immediate stimulation means for insertion into the human body or for placing on the human body.

When the extension is inserted into the human body, it serves to directly stimulate the affected part of the body. This supplements the further direct stimulation effect of the stimulation head on the clitoris. Direct stimulation of several erogenous zones can therefore take place simultaneously or alternately. For example, the extension can be inserted into the female vagina while simultaneously or alternately stimulating the clitoris with a specific external stimulation. The principle of combined direct stimulation of two erogenous zones (the clitoris and the vagina) according to the invention can also be modified accordingly. For example, the extension can be placed on the clitoris of one woman, while the stimulation head stimulates the clitoris of another or the same woman.

Thus, the stimulation device with extension can be used by only one person or also by two different persons to stimulate several erogenous zones.

The combination of two direct stimulation effects on two adjacent erogenous zones leads to an improvement of the stimulation effect and to a versatile application of the stimulation device. By means of the stimulation device with extension according to the invention, there are also other, alternative forms of sexual activity.

This provides a stimulation device with several cumulative orgasm- or stimulation-triggering effects, which is suitable for the stimulation of several erogenous zones, especially the female clitoris. Furthermore a device is provided which avoids drying out of the erogenous zones to be stimulated, is hygienic and avoids habituation effects.

The extension may be movable on the housing or may move with the housing, for example by means of a joint at one end of the extension. This allows the stimulation device to be adapted to the particular anatomy of the human body and to its use. For example, the extension can be inserted into the female vagina and then the angle between the stimulation head and the extension can be adjusted so that the stimulation head can be placed precisely over the clitoris. As a result, the area between the clitoris and vagina is stimulated from both sides, with the effects of the two direct stimulations intensifying each other.

If the extension is used as a handgrip to hold the stimulation device, the angle between the handgrip and the stimulation head can be adjusted according to the preferences of the user of the device.

The extension can be a stimulation means that is shaped in such a way that the extension can be inserted into the human body, for example into the vagina, for direct stimulation. The extension is preferably in the form of a dildo. Sharp edges are avoided in particular. The extension is preferably configured in such a way that it can be easily inserted into body orifices and/or remains inserted in these orifices. The stimulation device may be configured in such a way that the extension can be inserted into the vagina, while the stimulation head can rest on the clitoris, preferably simultaneously.

The extension may be an elongate, lenticular or pillow-shaped body adapted to allow the extension to be smoothly inserted into the female vagina.

The extension may be provided with the stimulation device in such a way that the stimulation device is uniformly configured. “Uniform” means in particular that the stimulation device with extension, housing and stimulation head is configured as an integrated, continuous device. Preferably, the transitions between extension, housing and stimulation head are seamless. This improves hygiene and the operability of the stimulation device.

The housing of the stimulation device may be such that it has an outer layer of silicone, rubber or a polymer which at least partially encloses the housing. This may, on the one hand, provide the uniformity of the stimulation device described above and, on the other hand, it may improve the feel and hygiene of the stimulation device.

The extension may have a vibration device (preferably also linear). This vibration device can be actuated in such a way that the extension vibrates. The vibration can either be activated independently of the other parts of the stimulation device, or the vibration can be controlled by the control device, which then also controls the drive device. Preferably, the vibration can be controlled in the usual, known way in terms of intensity, duration and sequence. With the vibration, the direct stimulation effect is increased.

The vibration device of the extension may be a linear drive device, as described in detail above. Thus, the stimulation device in this development has at least two linear drive devices: one generating the vibrations which stimulate the clitoris and the other generating the vibrations which stimulate the vagina. Preferably, the stimulation device is configured in such a way that the directions of the deflections of both linear drive devices into the interior of the body point to the same body region when the stimulation device is used. In this way, the body region that can be stimulated between the clitoral glans and the inside of the vagina is advantageously subjected to vibrations on both sides.

The stimulation device may have a heating element or a heating device for heating the stimulation head, the heating element preferably being accommodated in the wall or being arranged in the housing in the immediate vicinity of the wall.

In this case, the part of the housing (i.e. the wall that forms the head to be placed over the clitoris) that touches the skin or the sensitive clitoris can be preheated in an advantageous way. Thus, the temperature of the housing part can be adapted or approximated to the temperature of the skin, so that placing the housing part against the skin is perceived as less disturbing. The clitoral area in particular is sensitive to temperature differences.

Furthermore, the wall or housing part may be equipped with a heating element in the form of a semiconductor with a high electrical resistance, which is integrated as an extended electrical conductor on or in the plastic material of the housing part itself. When a potential difference is applied to this semiconductor, a current flows, the losses of which heat the conductor and, as a result of heat conduction, the wall.

If the semiconductor is integrated directly into a removable silicone head, the electrical conductor may be connected to the control device. This electrical contact can be made, for example, via magnetic connectors with permanent magnets. Thus, the heating element with the head is exchangeable.

The heating element can be mounted in the wall or in the housing in close proximity to the wall. In order to reduce the energy required for heating as well as the necessary warm-up time, the heating element can be thermally insulated in the direction of undesired heat conduction, i.e. towards the inside of the stimulation device. This thermal heat barrier can be realized with glass or mineral wool or a suitable plastic material, for example. Alternatively, a charging station or case for the stimulation device may be provided with a heating element of a negative form of the stimulation device to warm the stimulation device from the outside before it is operated.

As an alternative to the heating element, which can preferably consist of a semiconductor or a heating wire, the wall can be heated by inductively generated eddy currents. For this purpose, the wall can be provided with a grid and/or with conductor tracks made of ferromagnetic material with good thermal conductivity, the stimulation device being configured in such a way that eddy currents are induced in these conductor tracks. For this purpose, for example, an electric coil can be provided for building up a magnetic field, which is arranged in such a way that the magnetic field can act on the grid or the conductor tracks.

The stimulation head can be arranged exchangeably. For example, the head can be removed for easier cleaning. Differently shaped heads can also be used. This improves the hygiene and application flexibility of the stimulation device. In addition, a wall or wall portion of the stimulation head can form part of the outer wall of the housing, and the wall can be exchangeable in relation to the stimulation device.

According to another aspect, the stimulation device is a hand-held, preferably portable device. Such a device is more compact and easier to handle.

According to another aspect, the drive device can be an electromagnetic linear transducer without a moving permanent magnet. This avoids unwanted natural vibrations of the stimulation device, since a moving permanent magnet (as opposed to a moving conductor or coil) has a considerable mass, which requires correspondingly greater counterforces during acceleration and deceleration.

According to a further design, the stimulation device has a detection device for detecting the amplitude of the vibrations of the stimulation head (and/or the deflections of the drive device). With such a detection device, for example an inductive or optical displacement sensor, the control device can obtain feedback on the actual behavior of the stimulation head. This is advantageous for determining a malfunction of the drive device.

A detection device may be provided which can detect the current and/or voltage in the moving conductor. This may also provide feedback on the status of the drive device. For example, short circuits or other abnormal operating conditions can be detected.

The detection device can be coupled to the control device in such a way that a regulation is provided which is configured in such a way that it at least partially compensates for a damping of the vibration amplitude and/or a reduction of the vibration frequency of the stimulation head when the stimulation head is placed on the skin. If the stimulation head is placed specifically on the skin or clitoris, this can damp the vibrations generated by the drive device and/or can also reduce the vibration frequency at which the stimulation head vibrates. The more firmly the head is applied, the more the vibrations can be damped in amplitude or frequency, which can be a disturbing effect. Usually, a firmer placement of the stimulation device by the user on the clitoris is intended to have the opposite effect, i.e. to stimulate more intensely, as the climax may be approaching. If the amplitude and/or the frequency of the vibrations is now detected by the detection device, the corresponding detection signal can be transmitted to the control device. The control device evaluates the detection signal and compensates a possible reduction of the vibration amplitude and/or frequency, for example by increasing the control current and/or the control frequency. Thus, a control loop is provided in the stimulation device according to the invention, for example with a P (proportional), a PI (proportional-integral) or a PID (proportional-integral-differential) controller, which keeps the once set or predefined vibration amplitude and/or the vibration frequency constant, as far as this is possible (in terms of power). This is also independent of whether and how firmly the stimulation head is pressed onto the clitoris.

According to another aspect, the use of the stimulation device according to any of the previous explanations and aspects is intended as a sex toy for sexual pleasure and not for medical or therapeutic purposes. In particular, the present invention also does not concern the treatment of sexual disorders or even incontinence problems. This also applies to the methods explained here.

According to another aspect, a method for noise reduction of a stimulation device, and not for medical or therapeutic purposes, is provided, having the following steps:

switching on the stimulation device by the user, the stimulation device being in a standby mode after being switched on, in which the drive device is not activated;
detecting, by means of a sensor device of the stimulation device, whether a stimulation head of the stimulation device is approaching the clitoris or, alternatively, whether the stimulation head is touching the clitoris; generating an activation signal and outputting the activation signal to a control device; if an approach or touch has been detected by the sensor device, activating a drive device if the control device receives the activation signal and if the drive device is activated: generating vibrations of the stimulation head by the drive device for stimulation of the clitoris.

The function and the advantages of the method are the same as those already described above in relation to the associated device. In particular, the noise produced when the stimulation device is used is reduced, since the device is deactivated when it is not in the vicinity of the place of use.

According to another aspect, a method is provided for stimulating the clitoris for sexual pleasure and not for medical or therapeutic purposes, using a stimulation device according to one of the previous explanations and aspects.

According to another aspect, a system comprising one of the stimulation devices explained above and an operating device is provided. Such an operating device is preferably a commercial mobile phone with a touch-sensitive screen, or a radio remote control which allows the stimulation device to be operated. Possible communication protocols include Bluetooth or WLAN.

For example, different stimulation patterns, which are preferably displayed graphically in signal form, can be selected for stimulation via the operating device. Furthermore, a specific piece of music or a provided stimulation pattern can be selected for stimulation. These stimulation patterns could be made available for download by the manufacturer, and the stimulation patterns may include specific stimulation effects. Likewise, the stimulation patterns can be downloaded from the operating device, preferably into the control device of the stimulation device, so that they can be set independently of the operating device. Furthermore, there may be a possibility for the user to define the signal form, for example by drawing or by setting via a menu. In the same way, preferably different signal shapes, which are provided or stored in the software, can be assembled in a modular way.

In the case of the drive device of the stimulation device, coil elements of the coil assembly or moving coil formed separately from one another may be operable with different electrical currents during operation. If different electrical currents flow through separately formed coil elements, this makes it possible to design the repeated displacement of each coil element individually during operation, for example with regard to a deflection amplitude and/or a deflection frequency.

The coil assembly of the drive device can have an upper and a lower sub-coil which are arranged one above the other on the carrier of the coil winding. The upper and lower sub-coil may have separate electrical connections. During operation, they can be supplied optionally with different electrical currents. The different electrical currents can differ with regard to one or more current parameters, for example amplitude, polarity and/or temporal amplitude behavior. The upper and lower sub-coils are formed on the carrier separate from the displaceable head element.

The upper and lower sub-coils of the moving coil may be arranged opposite permanent magnets or pole plates at least in the neutral rest position about which they are then displaced or vibrated during operation, and a configuration may also be provided in which one of the sub-coils is opposite permanent magnets, whereas the other of the sub-coils is arranged opposite pole plates.

In the different embodiments of the drive device the permanent magnets can be arranged inside or outside the coil windings. An arrangement of the permanent magnets below the coil winding(s) may also be provided.

Provision may be made for the coil winding(s) mounted on the carrier to be moved (deflected) from a neutral rest position before the start of operation in which the displaceable head element is moved back and forth (or up and down) with respect to an initial position, and then to be moved or displaced around this shifted position during operation. During operation, the coil can be supplied with a current of non-alternating polarity, which simplifies the electrical supply. Such pre-displacement or deflection may be against a pretension device which provides a pretension force against the deflection, such as a spring mechanism. The pretensioning device providing the pretension can support the displacement of the coil assembly and thus the displaceable head element during operation.

According to another aspect, a method is provided for stimulating the clitoris for sexual pleasure, and not for medical or therapeutic purposes, using a stimulation device, wherein substantially rectangular or triangular or sawtooth-shaped vibrations are generated to stimulate the clitoris. The particular stimulation effect of such vibration forms has already been explained in greater detail above.

According to a further aspect, a method is provided for stimulating the clitoris for sexual pleasure, and not for medical or therapeutic purposes, using a stimulation device with a stimulation head, wherein vibrations of the stimulation head are generated which have at least two simultaneously occurring vibration frequencies. The particular stimulating effect of a multi-frequency stimulation has already been explained in greater detail above.

### BRIEF DESCRIPTION OF THE DRAWINGS

In the following, further embodiments are explained in greater detail with reference to figures in a drawing, in which:

FIG. 1 shows a front view of a first embodiment of a stimulation device;

FIG. 2 shows a perspective side view of the first embodiment of the stimulation device;

FIG. 3 shows a cross-section of the stimulation device from the first embodiment;

FIG. 4 shows a sectional view of an aspect of a drive device;

FIG. 5 shows a sectional view of an aspect of a drive device;

FIG. 6 a) to 6 d) show sectional views of aspects of drive devices;

FIG. 6 e) shows a view from below of the aspect of FIG. 6 d);

FIG. 7 a) to 7e) show different stimulation patterns;

FIG. 8 shows a block diagram of a functional structure of the stimulation device;

FIG. 9 shows a side view of a stimulation device of a second embodiment in a first, non-inserted state;

FIG. 10 shows a side view of a stimulation device of a second embodiment in a second, vaginally inserted state;

FIG. 11 a) shows a side view of a stimulation device of a third embodiment;

FIG. 11 b) shows a sectional view of a stimulation device of a third embodiment;

FIG. 12 a) shows a side view of a stimulation device of an aspect of the third embodiment;

FIG. 12 b) shows a view of the stimulation device of FIG. 12 a) from behind;

FIG. 13 a) shows a side view of a stimulation device of an aspect of the third embodiment;

FIG. 13 b) shows a view of the stimulation device of FIG. 13 a) from behind;

FIG. 14 a) shows a side view of a stimulation device of an aspect of the third embodiment;

FIG. 14 b) shows a view of the stimulation device of FIG. 14 a) from behind;

FIG. 15 a) shows a side view of a stimulation device of an aspect of the third embodiment;

FIG. 15 b) shows a view of the stimulation device of FIG. 15 a) from behind;

FIG. 16 a) shows a side view of a stimulation device of an aspect of the third embodiment;

FIG. 16 b) shows a view of the stimulation device of FIG. 16 a) from behind;

FIG. 17 shows a schematic view of a holder for a stimulation device of an embodiment;

FIG. 18 shows a schematic sectional view of a cup-shaped holder for a stimulation device of an embodiment;

FIG. 19 shows a schematic representation of an arrangement for a stimulation device, in which the coil assembly has separate coil windings and permanent magnets are arranged externally;

FIG. 20 shows a schematic representation of an arrangement for a stimulation device, in which the coil assembly has separate coil windings and permanent magnets are arranged inside;

FIG. 21 shows a schematic representation of an arrangement for a stimulation device, in which the coil assembly has separate coil windings and permanent magnets are arranged externally at the top;

FIG. 22 shows a schematic representation of an arrangement for a stimulation device, in which the coil assembly has separate coil windings and permanent magnets are arranged externally at the bottom;

FIG. 23 shows a schematic representation of an arrangement for a stimulation device in which permanent magnets are arranged inside the moving coil;

FIG. 24 shows a schematic representation of an arrangement for a stimulation device in which permanent magnets are arranged outside the moving coil;

FIG. 25 shows a schematic representation of an arrangement for a stimulation device in which permanent magnets are arranged below the moving coil;

FIG. 26 shows a schematic representation of an arrangement for a stimulation device in which the moving coil is pre-displaced from a neutral rest or starting position; and

FIG. 27 shows a schematic representation of another arrangement for a stimulation device in which the moving coil is pre-displaced from a neutral rest or starting position.

### DETAILED DESCRIPTION

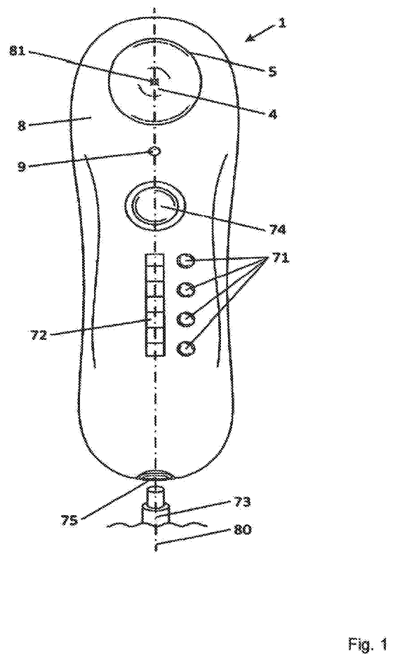

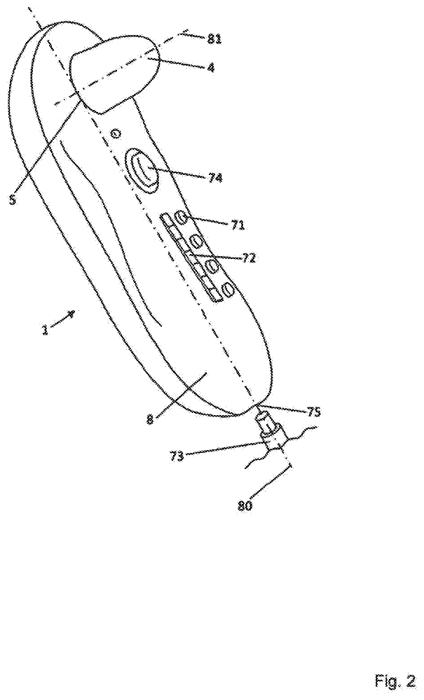

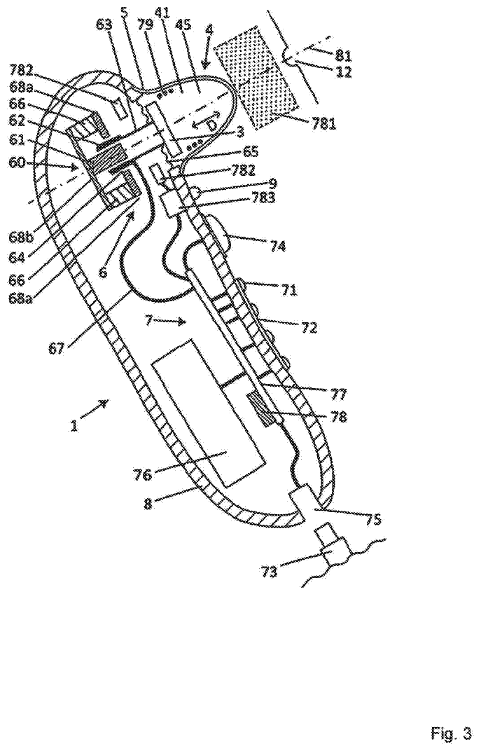

With reference to FIG. 1, a front view of a first embodiment of the stimulation device 1 according to the invention is explained, with FIG. 2 showing a perspective view and FIG. 3 showing a cross-section of the stimulation device 1 according to the invention of the first embodiment.

The first embodiment of the stimulation device 1 is a, preferably portable, electric or small device, which has a housing 8, a stimulation head 4 for placing on the clitoris 12, a transition 5 between the stimulation head 4 and the housing 8, operating elements 71, an indicator 72, an on/off switch 74, an optional socket 75, an optional battery 76 and an optional lighting system 9.

The housing 8 is preferably designed ergonomically so that it can be held comfortably with one hand and has no sharp or pointed edges. Furthermore, the housing 8 can be made of a plastic, for example polycarbonate (PC) or acrylonitrile butadiene styrene (ABS). In addition, the grip areas or even the entire housing 8 can be supplemented or configured with a silicone that is advantageous to the touch, for example in the form of a silicone cover. The housing 8 is preferably at least water-repellent or splash-proof, for example protection class IP 24. Furthermore, the stimulation device 1 can be made waterproof against immersion to at least 0.5 m under water for at least 30 minutes. For this purpose, a transition 5 between the stimulation head 4 and the housing 8 can also be configured to be waterproof; for example, this can be a glued or press fit. In addition, the housing 8 has a longitudinal axis 80, which is an imaginary axis running longitudinally from a front end 90 to a rear end 91. Furthermore, the stimulation device 1 has an alignment axis 81 (in FIG. 1 leading in and out of the plane of the drawing), which indicates the main directions in which the deflections of the vibrations of the stimulation head 4 take place, which are provided for stimulating the clitoris 12.

The operating element 71 or the operating elements 71 are used to set the operating mode of the device, i.e. to set the stimulation by the stimulation head 4. The at least one operating element 71 may, for example, be configured as at least one pushbutton, as at least one rotary switch, or as at least one touch-sensitive switch. Furthermore, the at least one operating element 71 can provide optical feedback on the actuation, for example by means of light-emitting diodes (LED) integrated in the switch.

An optional indicator 72 serves to inform the user about the status of the device and/or the setting status. The indicator 72 can, for example, be equipped with a single light-emitting diode, a plurality of light-emitting diodes or as an LCD display. The information displayed can be, for example, the power-on status of the instrument, the charge level of an optional battery 76 or the current setting of the modulation pattern.

The on/off switch 74 is used to activate and deactivate stimulation device 1. This on/off switch 74 can be, for example, a pushbutton that switches the stimulation device 1 on or off when pressed for a long time, or a snap-in slide switch.

A socket 75 is used for the external power supply of stimulation device 1 via an external plug 73, which is connected to an external mains adapter, for example. In order to ensure that the stimulation device 1 is splashproof, instead of the socket 75 a magnetic-inductive transformer can preferably be provided which enables power to be transferred to the stimulation device 1 without an electrically conductive contact. Preferably, the stimulation device 1 also has a battery 76, for example a nickel-metal hydride (NiMH) or lithium battery, for wireless operation. Alternatively, a (longer) power supply cable 116 can be led out of the stimulation device. Alternatively, magnetic contacts can also be provided as a power supply connection.

An optional lighting system 9 is provided on or in the housing 8. The lighting system 9 is preferably used to illuminate the stimulation head 4. The lighting system 9 can either be switched on by the user or be activated automatically when the stimulation device 1 is activated. Furthermore, the lighting system 9 can be formed by at least one energy-saving LED. The lighting system can, for example, serve as an orientation aid for the user of stimulation device 1 in the dark or as additional optical stimulation.

FIG. 3 shows a cross-section of a drive device 6 of the stimulation device 1. The drive device 6 has a moving coil assembly 60, which has a pole core 61, a coil or moving coil 62, a moving coil carrier 63 (carrier), an air gap 64 between a permanent magnet 66 and the moving coil 62, and a suspension 65, preferably a centering spider or centering membrane. The air gap 64 is preferably configured to be as small as possible in order to provide high field strengths in it. Furthermore, the moving coil 62 is movably suspended by the suspension 65 in such a way that it can vibrate back and forth along an imaginary straight line, i.e. the moving coil 62 can perform a linear movement with its moving coil carrier 63, as indicated by the double arrow D in FIG. 3. The suspension 65 is preferably made of an impregnated fabric or of an elastic material and supports the moving coil carrier 63 and thus the moving coil 62. The suspension 65, when viewed from above, can preferably be circular with a central recess. A front pole plate 68a and a rear pole plate 68b are preferably made of steel. In summary, the movably suspended moving coil 62 is immersed in the magnetic field of at least one permanent magnet 66.

If the moving coil 62 is now energized via the supply line 67, Lorentz forces act on the moving coil 62, and the moving coil 62 will move with the moving coil carrier 63 according to the current supply. In other words, the moving coil 62 can be driven in such a way that it vibrates back and forth in the magnetic field of the moving coil assembly 60. An advantage of the drive arrangement 6 is that the generated vibrations can be generated very flexibly and with great dynamics. In addition, the generated vibrations can have complex stimulation patterns which, for example, have at least two frequency components or predetermined waveforms. In addition, with the drive device 6 shown, forces can also be generated that are sufficient to stimulate the clitoris 12. A further advantage is that the drive device 6 preferably has a frequency response that can be provided evenly (<6 dB, determination via an FFT as described above) in the frequency range relevant for stimulation. This makes it possible to operate the stimulation device with a simple control system and effectively over the entire frequency range provided. In addition, such a drive device 6 vibrates only linearly, and not in a plane in undesired directions, whereby the generation of disturbing natural vibrations is already reduced in principle.

The moving coil carrier 63 is further coupled to a vibrating element 3, which transmits the generated movement or deflection to the stimulation head 4. Consequently, the stimulation head 4 will vibrate back and forth along the alignment axis 81, with the vibrations being transmitted to the clitoris 12 and the underlying tissue when the stimulation head 4 is placed on top of it.

Furthermore, the transition 5 between stimulation head 4 and housing 8 is formed in such a way that it can compensate for the deflections of the stimulation head 4 relative to housing 8. The vibrating mass of the arrangement of FIG. 1 to 3 explained above can now be kept quite small (compared to a drive with an unbalance), since only the moving coil 62 with the moving coil carrier 63, the vibrating element 3 and the stimulation head 4 need to be moved, with the latter three elements preferably being able to be made of non-metallic materials, and preferably of low-density materials.

Furthermore, the cross-section of the moving coil 62 and/or the pole core 61 and/or the moving coil carrier 63 may be substantially circular, or the cross-section may be square, rectangular or otherwise shaped.

The stimulation head 4 preferably has a silicone covering which surrounds a head element 45 which, for example, consists of a foam or a soft plastic. However, the entire stimulation head 4 can also consist of silicone or rubber.

The stimulation device 1 thus has a linear electrodynamic drive capable of causing the stimulation head 4 to vibrate with deflections whose direction is indicated by the double arrow D.

A control device 7 with a control board 77 controls, among other things, the drive device 6, the operating elements 71 and the indicator 72. The control device 7 and the drive device 6 are supplied with power from the internal battery 76 and/or the external power supply 73. Furthermore, the control device 7 can be connected via an antenna 78 to an operating device (not shown in detail) which enables remote control of the stimulation device 1.

In this embodiment, a sensor device 783 is also provided, which has a measuring range 781 (given here as an example only), which is provided at or before the stimulation head 4 of the stimulation device 1a. In this measuring range 781, an approximation or the existence of a surface or a body part (positive) can be determined. In relation to the application of the stimulation device, the clitoris 12 is thus preferably detected with the surrounding skin areas.

When it is switched on, the stimulation device 1 is in “standby” mode. In this standby mode, the stimulation device 1 is in operation, i.e. for example, the control device 7 is working because the user has switched on the stimulation device 1, but the drive device 6 is de-energized so the stimulation device 1 does not produce any vibrations. In addition, the sensor device 783 is in standby mode and carries out measurements or estimates at regular intervals.

More specifically, a capacitive sensor can be used as sensor device 783, with at least one measuring electrode 782 of the sensor device 783 preferably being arranged inside the housing 8. For example, the capacitance or the change in capacitance of the measuring electrode 782 (i.e. the operating capacitance between the measuring electrode 782 and an approaching counter-electrode such as the human body as a “grounded” counter-electrode) can be determined by the sensor device 783 in order to carry out a measurement. Subsequently, it is determined, for example by means of a threshold value and by comparing this threshold value with the measured value obtained, whether or not there is an approach of the clitoris 12 to the stimulation head 4 of the stimulation device. If an approach of the clitoris 12 is determined, the sensor device 783 generates an activation signal, which is evaluated by the control device 7. The sensor device 783 and the measuring electrode 782 can also be provided on the control board 77.

If the control device 7 receives such an activation signal, the drive device 6 is energized or activated, which generates vibrations. In this case, the stimulation device is in active mode. Consequently, the stimulation device 1 changes its mode of operation from standby mode to active mode when the control device 7 receives the activation signal from the sensor device 783.

If the stimulation device 1a is now removed from the clitoris 12 and the clitoris 12 consequently leaves the measuring range 781, this information is also transmitted by the sensor device 783 to the control device 7. For example, the sensor device 783 can generate a deactivation signal and transmit it to the control device 7, or the transmission of the activation signal described above from the sensor device 783 to the control device 7 can be stopped. The stimulation device then changes its mode of operation from active mode to standby mode. For example, it may be that the user repeatedly puts down the stimulation device 1 during operation, for example to relax briefly, and then places the stimulation device 1 back on the clitoris 12. As a result, the stimulation device 1 is advantageously switched to silent mode during such pauses, since it is then in standby mode in which the drive device 6 is not active. Energy of the battery 76 is also saved.

Furthermore, the measuring electrode 782 can be configured in such a way that the resulting measuring range 781 of the sensor device 783 is positioned in front of the stimulation head 4 at the point intended for placement on the clitoris 12. The measuring range 781 can extend directly (as shown in FIG. 3) in front of the stimulation head 4 in such a way that an approach of the clitoris 12 is sensed when it enters the measuring range 781 (or the measuring window). In FIG. 3 the device is shown in a state before the clitoris 12 and the surrounding skin enters the measuring range 781, in which the clitoris can be sensed preferably positively.

Furthermore, the sensor device 783 may also transmit an output signal to the control device 7 depending on the measured value (for example, the value of the determined capacitance). This signal may be a voltage signal or a digital bus signal, for example. This signal can, for example, be used to control the amplitude of the vibration generated in such a way that when the stimulation head is brought closer to the skin area, the vibration amplitude is increased. A maximum value of the vibration amplitude can also be provided, so that the regulation of the vibration amplitude takes place between 0 and the specified maximum value or the maximum value set by the user. In other words, according to another aspect, the stimulation device's vibration generation can not only be activated (in the sense of a mere on/off switch), but can be increased from zero to the desired vibration amplitude. In this way, the stimulation device is started up advantageously gently. In addition, the above functionality can also be applied when deactivating, which allows the stimulation device to be switched off gently in the same way. Furthermore, other parameters of the vibration can be controlled or regulated accordingly, for example the frequency can be controlled additionally or alternatively to the amplitude. In addition, a predetermined control curve can be stored in the control device 7, the curve relating to at least one predefined parameter of the vibration as a function of the transmitted measured value of the sensor device.

In addition, the proximity of the body to the stimulation head 4 as a whole can also be determined, for example using a capacitive or acoustic measurement principle. If the user now presses the stimulation device 1 more firmly onto the clitoral glans 12, the stimulation head 4 is pressed into the skin to a certain extent, whereby the stimulation head 4 is (partially) surrounded by tissue at its front portion. This can also be detected with a sensor, for example the capacitance of a capacitive sensor which has a measuring range around the stimulation head 4 is changed. Based on these considerations, according to another aspect of the invention, the amplitude, frequency or even a frequency composition can be adjusted or controlled in dependence on a further measuring range. This measuring range can surround the stimulation head 4, for example in a ring shape, with the central axis of this ring preferably coinciding with the alignment axis 81. A measuring range can also be provided laterally next to the stimulation head 4. This can, for example, extend in a portion parallel to the lateral surface of the stimulation head 4.

The measuring electrode 782 according to the invention may further be arranged in the immediate vicinity of, or adjacent to the drive device 6.

In particular, the measuring electrode 782 according to the invention can be arranged in a ring or semicircle around the moving coil assembly 60, thus creating a measuring configuration which has a high measuring sensitivity in the sensor device 783 in the direction of the alignment axis 81 of the stimulation device. Thus, in this case, an imaginary surface of the ring-shaped measuring electrode 782 is perpendicular to the alignment axis 81 and is advantageously arranged approximately parallel to an imaginary skin surface of the clitoris 12.

In addition, a shielding electrode (not shown in greater detail) may be provided to shield the measuring electrode 782 from undesirable interference effects (for example from interference capacitances). For example, the shielding electrode can be positioned behind the measuring electrode 782 from the viewpoint of the stimulation head 4 of the stimulation device, so that, for example, a hand holding the device is not detected.

Alternatively, a sensor device 783 can be provided in such a way that contact of the clitoris 12 with the wall 41 is detected. For example, the measuring range 781 can be provided in such a way that the extent of the measuring range 781 in the direction of the alignment axis 81 is very small, for example 0.5 mm. In addition, a contact sensor can also be provided in the wall 41 as a sensor device 783. Such a contact sensor, for example a probe or a conductivity sensor with two measuring electrodes, can detect direct contact of the skin with the wall 41.

Furthermore, the stimulation device 1 according to the invention can have a heating element 79, which is arranged in the wall 41 in the form of a spiraled conductor, for example. Thus, the wall 41 or also the stimulation head 4 as a whole can be heated preferably to skin temperature. The heating element 79 can be activated by the user, for example by means of an operating element 71. Alternatively or additionally, the heating element 79 can be automatically energized after switching on the stimulation device 1, for example in standby mode. Furthermore, a temperature measuring unit (not shown in detail) is preferably provided on or in the stimulation head 4 for regulating and in particular limiting the temperature to the usual skin temperature of clitoris 12.

Additional developments for the stimulation device 1 are presented below. All the features, embodiments, aspects and developments of the stimulation device 1 disclosed here can be combined with each other as long as this is technically feasible for a person skilled in the art.

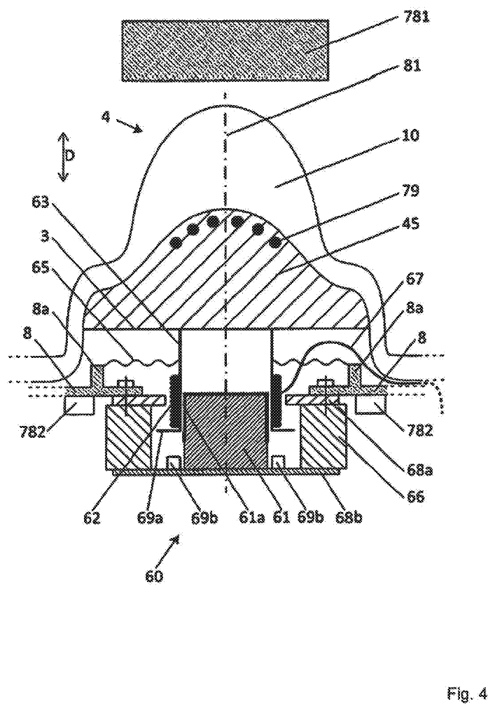

FIG. 4 shows a detailed representation of the drive device 6 of a further embodiment with a moving coil assembly 60. The same reference signs in FIG. 4 as in FIG. 1 to 3 denote identical or similar features with identical or similar functional properties. For this reason, the differences between the drive device 6 in FIG. 4 and the first embodiment are explained in greater detail below.

The moving coil assembly 60 is attached to the inside of the housing 8, which is made of ABS, for example. This attachment can be achieved by means of a screw connection, as shown, or by adhesive bonding (not shown). Furthermore at least one front stop element 69a (69c) is provided on the moving coil carrier 63 to limit the freedom of movement of the moving coil 62. If, for example, the stimulation head 4 is pressed towards the inside of the housing (i.e. downwards in FIG. 4), the front stop element 69a strikes the rear stop element 69b. If, conversely, the stimulation head 4 is pulled in a direction away from the inside of the stimulation device 1 (i.e. upwards in FIG. 4), the front stop element 69a strikes the front pole plate 68a. In such a design, the membrane 65 can be made of a material with usual (and not increased) strength, as potentially overloading forces are prevented by the stop elements (69a, 69b, 69c).

Furthermore, at least one holder 8a, for example in the form of a web or a fastening portion, is provided on the housing 8, on which holder the suspension 65 is provided. In this way, the suspension 65 can be advantageously fastened directly to the housing 8, which can absorb the forces which can act on the suspension 65. A head element 45 is provided on the planar vibrating element 3 and has a protruding shape or a convexly curved shape. This head element 45 preferably consists of a rigid plastic, for example ABS or PC, and optionally has at least one heating element 79 which serves to heat the stimulation head 4.

Furthermore, an outer layer 10, preferably made of an elastic material, is provided, which, for example, can at least partially surround the stimulation device 1 as a silicone layer and extends laterally from the housing 8 in such a way that it covers the stimulation head 4. The outer layer 10 in the area of the stimulation head 4 is preferably provided with a greater thickness than around it, whereby the stimulation head 4 is softer and more pleasant to the touch in the area intended to be placed on the clitoris 12. In addition, this layer 10 has a play or elasticity to compensate (in length) for the deflections of the vibrations of the stimulation head 4. Due to this outer (continuous) layer, the stimulation device 1 is advantageously sealed, at least at this point, and the ingress of dust or water into the interior of the drive device 6 is prevented. In addition, the measuring electrode 782 is provided adjacently to the moving coil assembly 60, and therefore the measuring range 781 can be provided advantageously in front of the stimulation head 4. For example, the measuring electrode is an at least largely ring-shaped capacitive measuring electrode 782. Furthermore, the stimulation head 4 can also be provided in one piece, for example made of silicone.

The stimulation head 4 as well as the moving coil 62 is moved along the alignment axis 81 (see also the double arrow D), which means that the vibrations can act directly on the clitoris 12 when the stimulation head 4 is placed thereon.

Furthermore, an impedance control ring 61a may preferably be provided on or at the pole core 61 to further improve the electrodynamic properties of the moving coil assembly 60. The inductance of the moving coil causes its impedance to rise as the frequency of the drive signal increases. The impedance control ring can reduce or compensate for this effect.

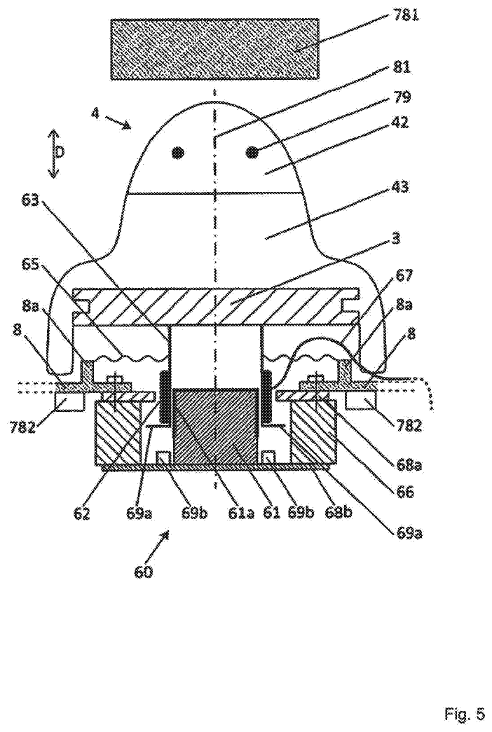

FIG. 5 shows a detailed representation of the drive device 6 according to the invention in accordance with a further embodiment with a moving coil assembly 60. Identical reference signs in FIG. 5 as in FIG. 1 to 3 denote identical or similar features with identical or similar functional properties. For this reason, in particular the differences between the drive device 6 in FIG. 5 and the first embodiment are explained in greater detail below.

The stimulation head 4 of FIG. 5 is arranged exchangeably (preferably by means of a clamp fit) and is also divided into a front portion 42 and a rear portion 43. For example, the rear portion 43 is made of silicone, which can be engaged with a lateral engagement 31 of the vibrating element 3 to attach the stimulation head 4 to the vibrating element 3. The front portion 42 is made of a very soft material, for example with a compressive modulus of elasticity lower than 0.1 N/mm², preferably lower than 0.05 N/mm², in particular lower than 0.01 N/mm², and comprises the heating element 79. This improves the haptic properties of the stimulation head 4.

A one-piece, exchangeable stimulation head 4, preferably made of silicone, may also be provided.

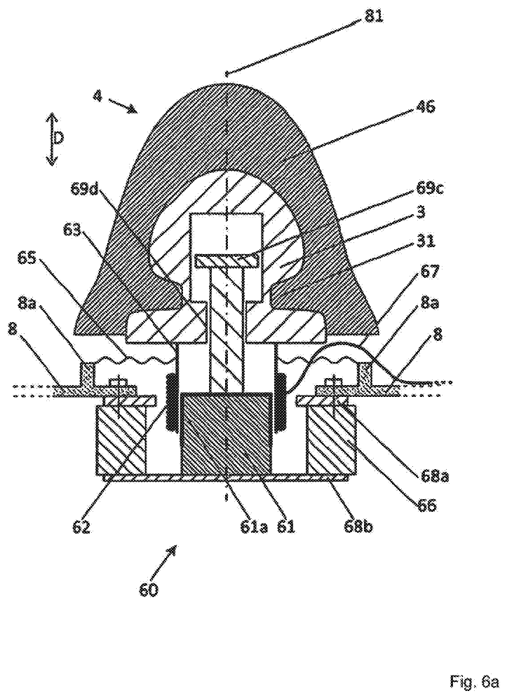

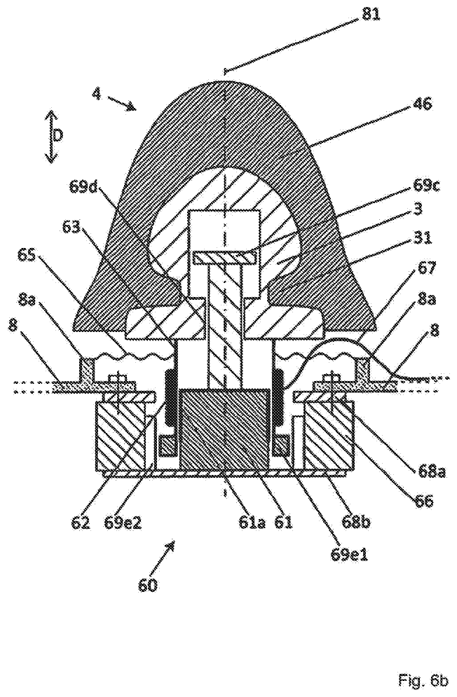

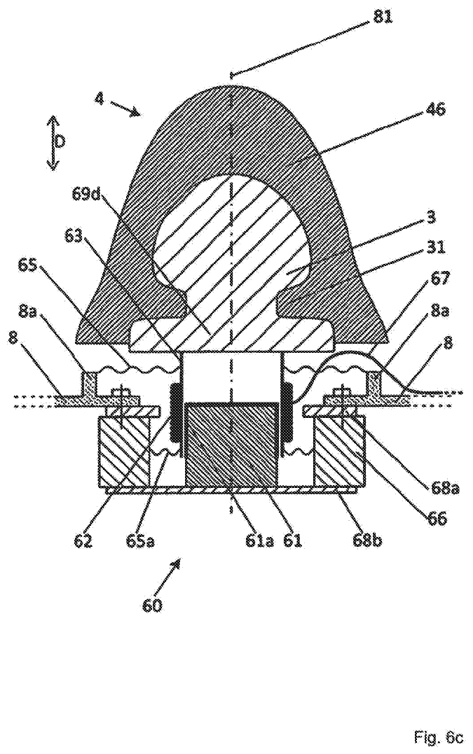

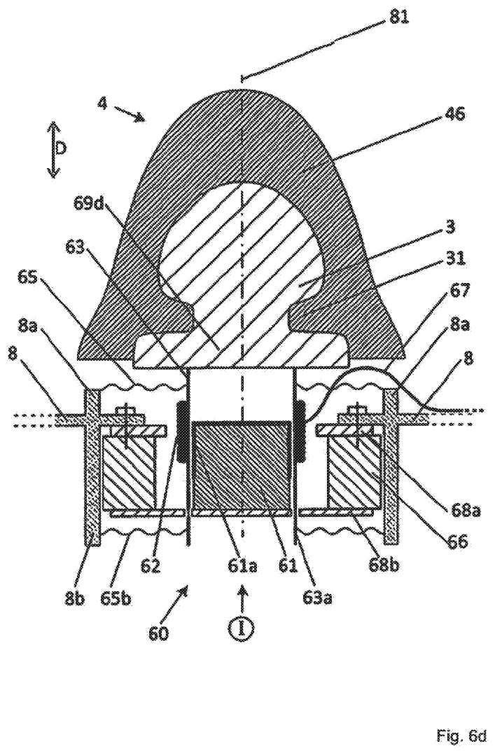

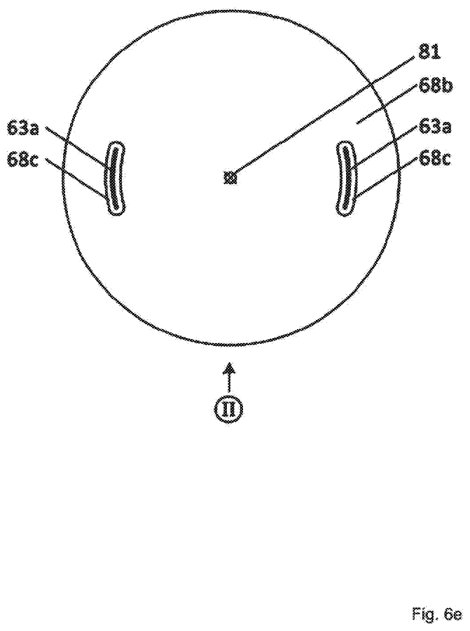

FIG. 6 a) to e) show detailed representations of drive devices 6 according to the invention according to further aspects, each with a moving coil assembly 60. Identical reference signs as in FIG. 1 to 3 denote identical or similar features with identical or similar functional properties. Therefore, in particular the differences between the drive device 6 of FIG. 6 a) to e) and the first embodiment are explained in detail below.

Referring to FIG. 6 a), the stimulation head 4 is again exchangeable, although it may be made in one piece, for example from rubber. Furthermore, a stop element 69c is provided which is mounted on a rod or pin extending along the alignment axis 81 of the pole core 61. Furthermore, a vibrating element 3 is provided which has a cavity in which the stop element 69c is provided. The vibrating element 3 has a freedom of movement which is determined by the length of the cavity. If the stimulation head 4 is pulled or pressed too tightly, the stop element 69c strikes one of the sides of the cavity. Furthermore, a guide 69d is provided to prevent excessive tilting of the moving coil carrier in the moving coil assembly, with a through-hole, for example a hole with a circular cross-section, possibly being provided in the vibrating element 3 for the rod. The guide 69d can be arranged in such a way that it can slidably receive the rod (connected to the pole core 61). In addition, the guide can be provided with a lubricant, for example silicone oil. The guide can also be configured in such a way that the friction losses are as low as possible, for example self-lubricating and/or low friction loss materials can be used. It is also possible to provide a larger clearance (for example more than 1 mm) with regard to a tilting of the stimulation head 4, as this is sufficient to prevent damage, particularly to the suspension 65. In this way, excessive tilting of the stimulation head 4 can be prevented, thus avoiding damage to the suspension 65, the moving coil carrier 63 and/or the moving coil 62.

In addition, the vibrating element 3 may have a mushroom-like shape, which has a circumferential engagement 31 for the stimulation head 4, whereby the stimulation head 4 can be easily attached to or removed from the vibrating element 3.

FIG. 6 b) shows a modification of the aspect of FIG. 6 a). Here too, an exchangeable stimulation head 46 is provided, which can be easily attached to the stimulation device 1 and removed from it again by means of a shape adapted to an engagement 31 (for example a projection). In this way, exchangeable stimulation heads 4, 46 can be provided that are adapted to the anatomy of the user or to the user's presence.

In this aspect, a guide 69d can also be optionally provided to increase the mechanical robustness of the arrangement.

In addition, compared to FIG. 6 a), further stop elements 69e1 and 69e2 are provided. The stop element 69e1 is provided on the moving coil carrier 63 and is preferably made of a plastic material (for example a material with a low density so as not to impair the dynamics of the moving coil assembly). In addition, a further stop element 69e2 is provided which is arranged at a distance from the stop element 69e1 via a gap. The stop element 69e2 can also be made of a plastic material. In particular, the stop elements 69e1 and 69e2 may consist of a soft and/or elastic material, for example foam or rubber. A material with self-lubricating properties can also be used as the material of the stop elements 69e1 and 69e2, which reduces the possibility of the arrangement becoming wedged. Furthermore, the stop elements 69e1 and 69e2 may be arranged in such a way that their opposite end faces are parallel to each other, while the edges of at least the stop element 69e1 are chamfered or rounded in order to reduce possible abrasion or grinding marks. Furthermore, the stop elements 69e1 and 69e2 may be provided as rings completely surrounding the pole core, which is easy to manufacture, or the stop elements 69e1 and 69e2 may also be provided only in portions in order to save weight.

If a force acts laterally on the stimulation head 3, the moving coil carrier 63 can tilt laterally with respect to the pole core 61 and possibly tilt, which is undesirable as the mechanics and especially the suspension 65 may be damaged. More specifically, it can be assumed that approximately at the level of the suspension 65 there is a mechanical pivot point of the suspended arrangement with respect to forces acting laterally on the stimulation head 4, which means that in the event of a lateral load on the stimulation head 4, especially the lower end of the moving coil carrier 63 can also be deflected laterally. Under certain circumstances, the stimulation head 4 can also be used to exert a detrimental leverage effect on the moving coil assembly 60. However, such a deflection can be limited by means of the two complementary stop elements 69e1 and 69e2, thus preventing damage. In addition, the stop element 69e1 also counteracts an excessively firm depression of the stimulation head 4, since in this case the stop element strikes against the lower pole plate 68b.

It should be noted that the stop elements 69e1 and 69e2 may also be provided without a stop 69c together with its associated pin and also without a guide 69d in order to provide a stop against tilting or depression of the stimulation head 4 and the moving coil carrier 63 with respect to the simulation device 1.

FIG. 6 c) shows another aspect of a moving coil assembly 60 that can reduce the risk of damage (as explained above). This can be achieved in particular by forces acting laterally on the stimulation head 4.

Instead of at least one stop, as in the aspect of FIG. 6 a), a further suspension 65a is provided in this case, which (like or similarly to the suspension 65 described above) provides a further bearing for the moving coil carrier 63. The further suspension 65a may in particular consist of a non-magnetic material, for example an elastomer, so as not to impair the magnetic field and thus the function of the drive. In particular, an impregnated fabric or a membrane made of a fluoroelastomer can be used.

This double bearing of the moving coil carrier makes it possible to avoid tilting without increasing the weight of the movably suspended arrangement too much, thus achieving sufficient dynamics of the moving coil assembly 60 while maintaining mechanical robustness.

Moreover, the use of two suspensions 65, 65a improves the mechanical robustness of the stimulation head 4, even when it is pushed in or pulled out, as the forces exerted can now be absorbed by two suspensions 65, 65a.

Another possibility to increase the mechanical robustness of the moving coil assembly 60 is shown in the related FIGS. 6 d) and 6 e). FIG. 6 d) shows, in particular, the pole plate 68b, extensions 63a of the coil carrier 63, a suspension 65, another suspension 65b and a housing receptacle 8b in a side view (see 11 in the circle with arrow in FIG. 6 e) for the direction of view). FIG. 6 e) shows a bottom view (see “I” in the circle with arrow in FIG. 6 d) for the direction of view) of only the lower pole plate 68 b) and the extensions 63a, the other elements of FIG. 6 d), for example the suspension 65b and the housing receptacle 8b, having been omitted for reasons of clarity.

Thus, similarly to FIG. 6 c), two suspensions 65, 65b, or centering spiders are provided for this aspect as well, which together counteract both excessive deflection along the axis 81 and excessive lateral deflection (for example in a left-right direction in the plane of the paper of FIG. 6 d), since there are now two suspension points for the coil carrier 3. The further suspension 65b is provided outside the radial area of the pole core 61, which simplifies production and further improves the mechanical robustness, as the distance between the suspension points of the two suspensions 65, 65b is increased compared to the aspect of FIG. 6c. More specifically, with the construction of this aspect, forces acting laterally on the stimulation head 4 can be better absorbed. In addition, suspensions 65, 65b of the same size can also be used advantageously, which simplifies the production.

Furthermore, the lower pole plate 68b of FIGS. 6 d) and 6 e) is provided with two openings 68c so that two extensions 63a of the moving coil carrier 63 can pass through them. The suspension 65b is attached to these extensions 63a.

However, more than two extensions 63a and corresponding openings 68c may also be provided, for example four or eight. This can further improve the mechanical robustness. The lower pole plate 68b, for example, can also be square or oval in shape, in contrast to FIG. 6 e). In the same way, just a single opening 68c in the lower pole plate 68b may also be provided for the passage of a single extension 63a.

The precise determination of the number of openings 68c (and the corresponding extensions 63a) is a trade-off between the mechanical stability caused by increasing the number of extensions 63a and the obstruction of the magnetic flux in the lower pole plate 68b through the openings 68c. Two or three openings 68c are preferred.

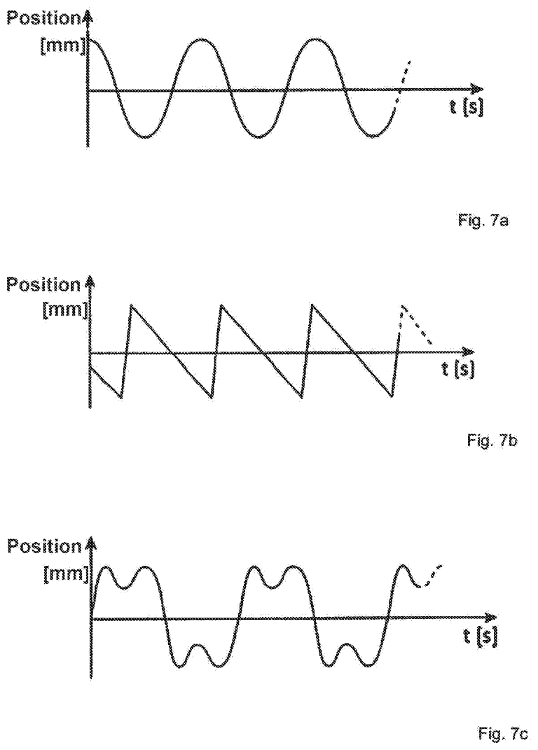

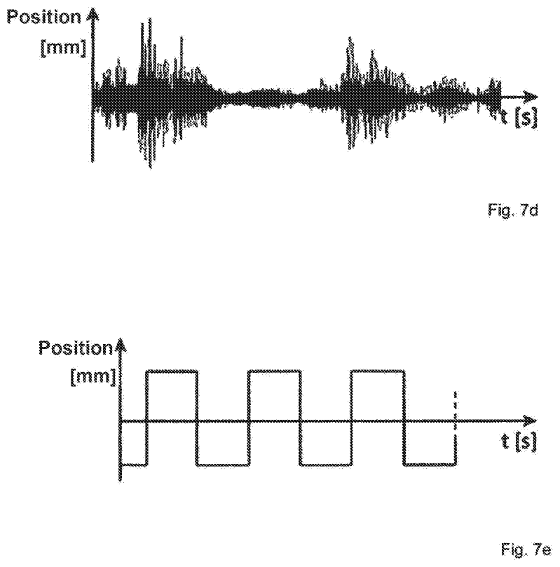

FIG. 7 a) to 7 e) show examples of different stimulation patterns according to the invention and the temporal profiles of vibrations of the stimulation head 4. These stimulation patterns are represented in an idealized way. In particular, the amplitude of the vibration can also depend on the pressure of the stimulation device 1 on the clitoris 12. The vertical axis of these FIG. 7 a) to 7 e) indicates the deflection of the stimulation head 4 and amplitude along the alignment axis 81 caused by the drive device 6 to an imaginary position on the alignment axis 81. The zero line or horizontal axis preferably indicates the rest position of the stimulation head 4. However, a rest position can also deviate from the displayed zero line; in particular, the zero line can also be shifted vertically. This can be the case, for example, if the drive device 6 is supplied with an AC voltage with a DC component.

Here FIG. 7 a) shows a simple (co-)sinusoidal vibration which can be generated, for example, by controlling the drive device 6 with a (co-)sinusoidal excitation current as the control pattern.

FIG. 7 b) shows a sawtooth-shaped stimulation pattern, which is a specific variant of a triangular stimulation pattern. The stimulation head 4 is moved away from the clitoris 12 at a nearly constant speed and then abruptly moved towards it. This leads to a more intense stimulation experience, whereby under certain circumstances a tingling sensation can be created. One reason for this is the sudden (abrupt) change in speed of the stimulation head 4, which is not present in a sinusoidal stimulation pattern, for example.

Thus, it was a further finding of the present inventor from experiments with a stimulation device with a dynamic and linear drive according to the invention that the clitoris 12 can differentiate between different vibrations, i.e. for example vibration frequencies, vibration amplitudes, vibration patterns, due to the presence of a multitude of nerve cells. The clitoris 12 has up to approximately 8,000 nerves and sensory cells, such as mechanoreceptors, also known as Vater-Pacini corpuscles, for vibration or vibration sensation and Meissner corpuscles for touch sensation.

Correspondingly, the mechanoreceptors of the Vater-Pacini corpuscles of the clitoris 12 can be stimulated with trained stimulation patterns, which can convey a vibration sensation to the user particularly well. The Vater-Pacini corpuscle belongs to the rapidly adapting receptors. It reacts to (positive and negative) acceleration and is therefore suitable as a vibration detector. According to medical findings, the highest sensitivity of these cells is at a vibration around 300 Hz, at which a deformation of a few micrometers is sufficient to excite the receptors. Concerning clitoral stimulation, experiments by the present inventor have shown that there is a good stimulation effect with frequencies up to approximately 170 Hz. Furthermore, stimulation patterns with frequency mixes can lead to different stimulation experiences of the user, which is advantageous. Thus, with the stimulation device according to the invention, it is now possible to create an improved stimulation experience.

A sawtooth-shaped stimulation pattern further leads to further frequency components in the stimulating vibrations that can be felt.

The sawtooth pattern can also be reversed, with an abrupt path movement and slower outward movement of the stimulation head 4. Similarly, stimulation can be performed with a triangular stimulation pattern that has a similar stimulation effect.

FIG. 7 c) shows vibrations or deflections of the stimulation head 4 which are the result of the addition of two fundamental vibrations with different amplitude and frequency. Preferably, it is the first harmonic added to a fundamental vibration. Such a multi-frequency vibration can provide an alternative, improved stimulation experience. For example, a fundamental frequency suitable for clitoral stimulation can be approximately 80 Hz.

FIG. 7 d) shows a stimulation pattern that has a complex sequence of vibrations. Similarly to a piece of music, a stimulation pattern can be “composed”, which can offer a varied stimulation experience. Such a stimulation pattern can, for example, be stored in the control device 7 in the form of an audio file and can be called up by the user as desired.

FIG. 7 e) shows an (idealized) square wave, which has very many frequency components. With such a stimulation, a stimulation effect with a multi-frequency stimulation of the clitoris 12 can be achieved.

The terms “vibration” and “vibrations” are used synonymously herein. According to the invention, vibrations are described as repeated temporal changes of at least one state variable of stimulation device 1. For example, and preferably, this is the recurrent deflection of the stimulation head 4 of the device 1 according to the invention.

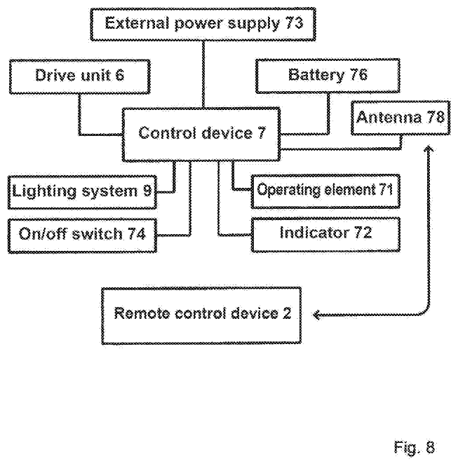

FIG. 8 shows a block diagram of an example of a functional structure of an embodiment of the present invention with a control device 7, a drive device 6, a lighting system 9, an on/off switch 74, at least one operating element 71, a battery 76 and an external power supply 73. This basic structure of the control device 7 can be applied, in essence, to all disclosed aspects and embodiments. Furthermore, an antenna 78 (or an alternative communication device) is provided to communicate with a remote control device 2.

The control device 7, which, for example, has a microcontroller or is hard-wired, first of all controls the power supply of all consumers of the stimulation device 1, as well as optionally a charging and discharging process of the battery 76 and/or a battery management system. In particular, the control device 7 controls the excitation of the drive device 6, for example the magnitude of the deflection, the frequency, the modulation, etc.

Furthermore, the control device 7 can optionally have a memory, in which there is stored at least one modulation or stimulation pattern (these will be explained in greater detail in conjunction with FIG. 7 a) to 7 e). The drive device 6 can now be controlled according to these prestored stimulation patterns by the user of stimulation device 1 using the operating elements 71. The stimulation patterns can optionally also be individually created and stored by the user via the operating elements 71 or via the remote control device 2. For example, the remote control device 2 can have a program for creating your own stimulation patterns (or waveforms).

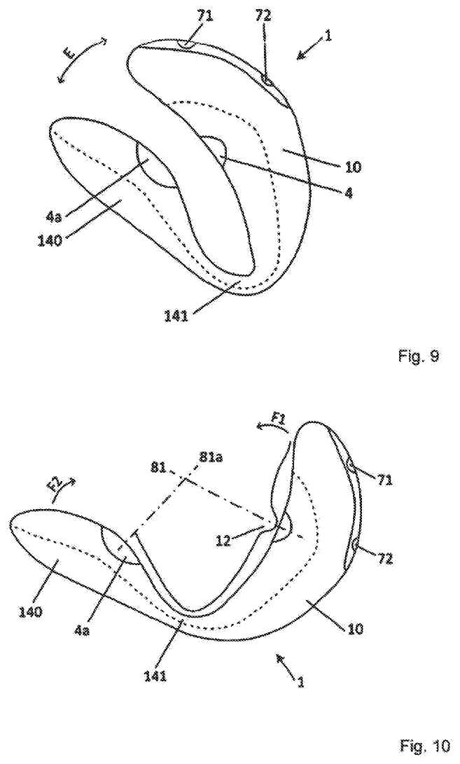

FIGS. 9 and 10 show a second embodiment of the stimulation device 1, which has an extension 140 intended for insertion into the vagina, for example in the form of a dildo. The extension 140 is preferably connected to the main body of the stimulation device 1 via a flexible connection 141, for example an elastic joint made of silicone. This allows the stimulation device 1 to be bent apart in the direction of the double arrow E. Furthermore, FIGS. 9 and 10 show a front visible edge of the stimulation device 1 by a dotted line. Furthermore, the stimulation device 1 is preferably provided with an outer (for example silicone) layer 10. On one side of the main body at least one operating element 71 and one indicator 72 are provided.

FIG. 9 shows the stimulation device 1 in a state in which it is not used on the body. FIG. 10 shows the stimulation device 1 in a state in which it is inserted vaginally via the extension 140 and the main body outside the human body rests on the clitoris 12 via the stimulation head 4. The stimulation device 1 is dimensioned in such a way that the main body, with its stimulation head 4, can rest on the outside of the clitoris 12 while the extension 140 is simultaneously inserted vaginally. The vaginal entrance is located at the point of the, preferably flexible, connection 141.

Furthermore, the stimulation device 1 of the second embodiment is preferably configured in such a way that, after bending apart and inserting stimulation device 1, forces F1 and F2 act as indicated by the corresponding arrows in FIG. 10. This ensures that the stimulation heads 4 and 4a rest well on the skin. With the clamping effect shown, the stimulation device 1 can also hold itself in place under certain circumstances without having to be held in place using the hands. Furthermore, the connection 141 is preferably tapered in relation to the extension 140 and the main body in such a way that the stimulation device 1 can be used during sexual intercourse (penetration).

The stimulation device 1 has (at least) two linear drive devices 6 (not shown in detail) according to the invention for stimulation, which have already been described in detail above. Furthermore, the stimulation heads 4 and 4a are integrated into the surface of the stimulation device 1. For this purpose, for example, the vibrating element 3 can be provided directly under the (outer) silicone layer 10.

Two alignment axes 81 and 81a are provided in such a way that they point to the same body region in the inserted state. The clitoris 12 is an organ which also occupies considerable space under the clitoral glans. Accordingly, the second embodiment of the stimulation device 1 can exert a stimulating effect on the clitoris 12 from two sides, since the vibrations generated spread into the clitoral region from two sides and thus improve the stimulation effect. In addition, the vagina is also stimulated with the vibrations according to the invention.

It will be appreciated that this embodiment can also be modified in such a way that it only has one linear drive device 6. Furthermore, in this case a further unbalanced excited vibration generation can also be provided.

In the following, with reference to FIG. 11 a) a side view of a stimulation device 1 according to the invention in accordance with a third embodiment and, with reference to FIG. 11 b), a sectional view of a stimulation device according to the invention in accordance with the third embodiment are shown. Identical reference signs in FIGS. 11 a) and 11 b) as in other figures, in particular FIG. 1 to 3, denote identical or similar features with identical or similar functional characteristics, therefore the differences between the drive device 6 of FIGS. 11 a) and 11 b) and that of the first embodiment are explained in greater detail below.

An elongate pen-shaped (or wand-shaped) housing 8, which is shown in FIG. 11 a), extends along a longitudinal axis 80 and has the stimulation head 4 at the front end 90. Such a housing form has advantages in terms of handling when stimulating the clitoris 12. The stimulation head 4 is provided at the front end 90 of stimulation device 1. Furthermore, the longitudinal axis 80 and the alignment axis 81 coincide, which makes operation easier, as users are used to guiding a pen. A head element 45, for example made of silicone, has a coating 44 which improves the surface quality of the stimulation head 4 of stimulation device 1. Furthermore, a moving coil assembly 60 is provided as the drive device 6, which is similar in respect of its components and function to one of the moving coil assemblies 60 of FIG. 3 to 6. For example, the moving coil assembly 60 has a moving coil, pole plates, an air gap, etc. Identical reference signs also denote identical or similar components here, and therefore a more detailed description of these can be omitted here.

The longitudinal axis of the housing of the stimulation device according to the invention is an imaginary axis extending from a front end of the elongate housing to a rear end (axially spaced from this front end) of the elongate housing. Preferably, the longitudinal axis is parallel to the length of the housing.

Usually, but not exclusively, the longitudinal axis may be an axis running lengthwise to the longest extent of the stimulation device.

For example, the longitudinal axis corresponds to the direction of the greatest total extent of the housing.

To fix a cuboidal and hollow cap 85, snap-in catches 862 are provided, which engage when the cap 85 is pushed over the front end 90 and over the middle portion 88 of the housing 8 until the stop edges 861 and 851 are in mutual contact. The cap 85 is shown in FIG. 11 a) arranged next to the housing 8, merely for simplification.

The center of mass MA of the stimulation device 1 is located in the rear portion 86, which makes said device easier to handle. Furthermore, the center of mass MA is preferably configured so that it is located on the longitudinal axis 80. This also improves the handling of the stimulation device 1, as lateral tilting moments are reduced or avoided. Furthermore, the position of the center of mass MA explained above could also be balanced or adjusted with additional (small) weight elements inside the housing 8.

The longitudinal axis 80 represents an axis of symmetry for the cap 85, for the rear portion 86 and for the middle portion 88.

For example, the housing 8 is about 4 cm wide (reference sign C), and about 12 cm long (reference sign A). Alternatively, the housing 8, for example, is about 3 cm wide (reference sign C) and about 12.5 cm long (reference sign A). Thus, during the development of the stimulation device, it has been shown that the resulting internal volume of the housing 8, with the alternative dimensioning of the housing 8 above, has just enough space to accommodate the components (motor, battery, control device, etc.) of the stimulation device 1.

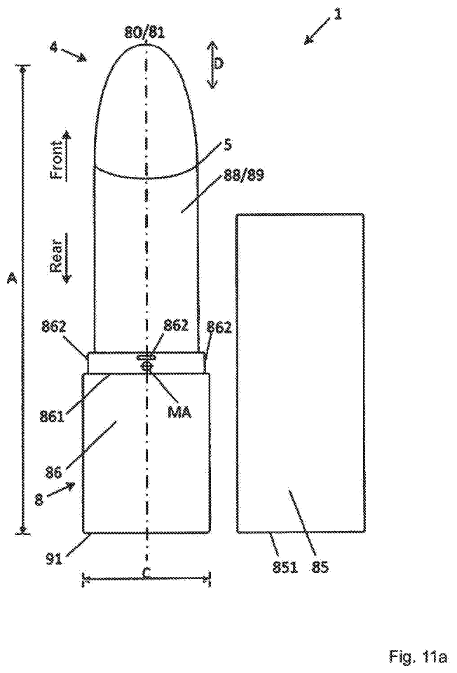

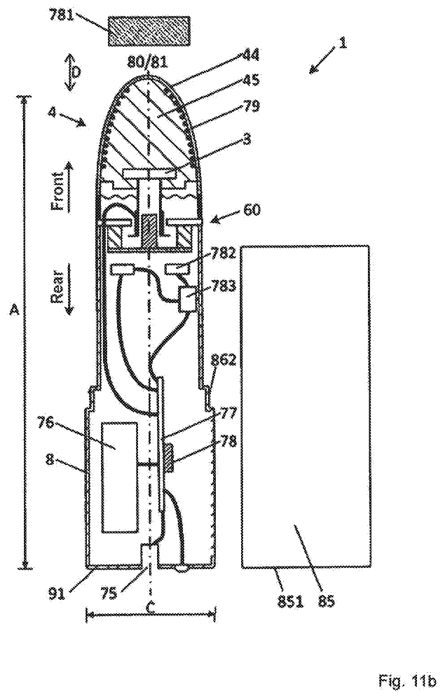

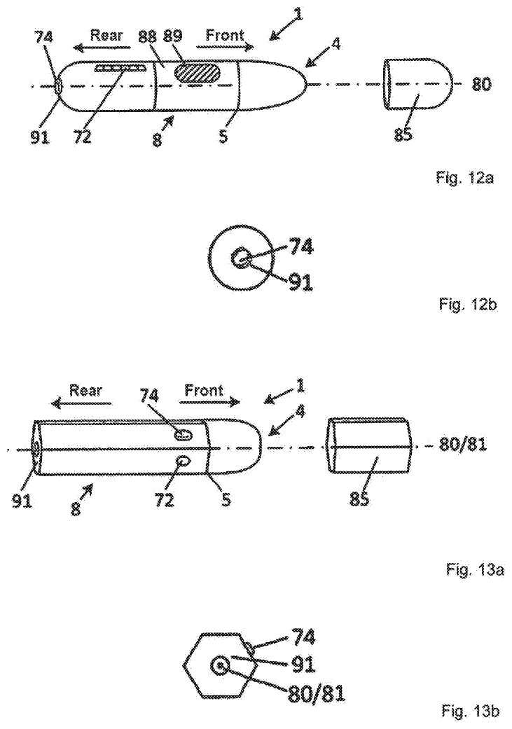

Referring to FIG. 11 b), which shows, from the front, a sectional view of the stimulation device 1 (or rather, on the left side of FIG. 11 b) the housing 8 and on the right side of FIG. 12 b) the cap 85), the outer contour of the middle portion 88 and the stimulation head 4 of the stimulation device 1 can be seen.

The cap 85 according to the invention preferably has a square basic cross-section, which is slightly convex.

On the rear side of the housing 8 (not shown in detail), an on/off switch 74 with an associated illuminated ring 72 as indicator is provided centrally within a set-back or recessed end face 863. Furthermore, a socket 75 is provided for the connection of a power supply. This socket 75 can be closed with an appropriately sealing stopper.

The following FIG. 12 a) to 16 b) show further advantageous embodiments or aspects of a pen-shaped stimulation device 1 of the third embodiment.

FIGS. 12 a) and 12 b) show an elongate and rod-shaped stimulation device 1 with a housing 8 (for example made of ABS plastic), a front end 90, and a rear end 91, the stimulation device 1 being circular in its cross-section or in the outer contour in its cross-sectional plane. An on/off switch 74 is provided in the rear end, which optionally has a light element for indicating the switched-on state. An optional indicator 72 can show the current setting of the modulation pattern or the strength of the stimulation. A middle portion 88 is optionally coated with silicone, while a grip surface 89 (and another grip surface 89 on the opposite side, which is not shown in detail) in the form of an elongate oval surface (for example as a superellipse) indicates the preferred support position for the fingers and ensures a good grip of the fingers. These grip surfaces 89 may, for example, be color-coded, or an additional rubber coating may be applied to the surface of the middle portion 88.

A cup-shaped cap 85 complementary to the front end 90 or matching in shape is configured in such a way that it can be attached to the front end 90 in a manner similar to the cap of a pen. When fitted, the cap 85 covers (and protects) the front stimulation head 4 of the stimulation device 1 and extends longitudinally as far as the transition 5 or the interface of the wall 41 at the front end 90 to the middle portion 88.

Preferably, the outer diameter of the cap 85 in the transverse direction is equal to the outer diameter of the housing 8 in the transverse direction.

The stimulation head 4 of the stimulation device 1 is located in the front end 90, with the longitudinal axis 80 passing through the stimulation head 4. The directions “front” and “rear” are indicated accordingly in the drawing by the arrows. The front end 90 is the “active” end used for stimulation.

The on/off switch 74 can preferably be recessed in the housing 8 so that it does not protrude from the housing 8.

The longitudinal axis 80 is an imaginary line between the front end 90 and the rear end 91, which in the case of FIG. 7 a) and FIG. 7 b) also represents the axis of symmetry for the basic shape of the housing 8. These symmetry considerations do not take into account, for example, an on/off switch 74, indicators 72 or grip surfaces 89, which represent only minor adaptations of the basic shape of housing 8.

An alignment axis 81 can also cut the longitudinal axis 80 preferably at an angle of approximately 30 degrees, which further improves the handling.

Thus, the stimulation device 1 according to the invention has a compact, elongate and slim design. This leads to weight savings and ergonomic handling of the stimulation device 1. Preferably, the stimulation device 1 of FIGS. 12 a) and 12 b) is waterproof (IP67). For this reason and because of the simple external shape of the stimulation device 1, it is easy to clean.

Referring to FIG. 13 a) a side view of a stimulation device according to the invention, and referring to FIG. 13 b) a view of the stimulation device of the invention of FIG. 13 a) from behind is explained in greater detail.

The second embodiment has a regular hexagonal housing 8, which has a flat rear end 91. This allows this housing 8 to be placed or even laid down without rolling away. The shape of the housing thus serves as a roll stop. The on/off switch 74 and the indicator 72 are located adjacently to the front end 90. The cap 85 has a design similar to the first embodiment and fits the shape of the housing 8 of the second embodiment accordingly.

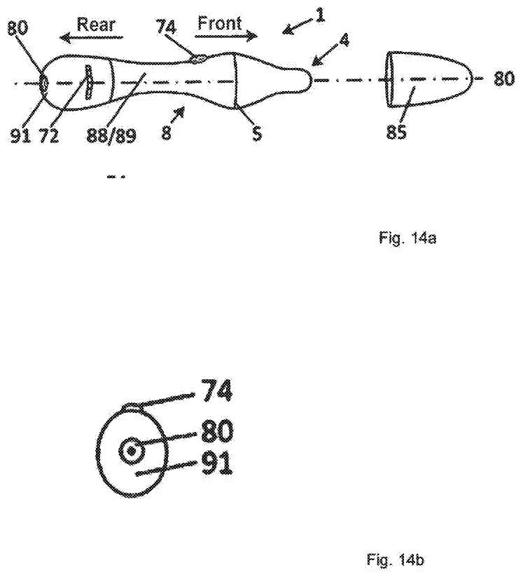

With reference to FIG. 14 a) a side view of a stimulation device according to the invention in accordance with a third embodiment, and with reference to FIG. 14 b) a view of the stimulation device according to the invention of FIG. 14 a) from behind is explained in greater detail.

The housing 8 of this embodiment is waisted in the middle for example, and tapers accordingly towards the middle. The two thickenings or bulges on the left and right of the central taper—viewed in the longitudinal direction of the housing 8—preferably both have the same maximum radius in the transverse direction. The housing 8 thus has a shape similar to a dog's bone.

The cross-sectional shape of the housing 8 is approximately oval, and is preferably maintained with the same width/height ratio over the entire length of the housing 8. This means that the housing 8 fits comfortably in the hand and does not roll away easily when the stimulation device 1 is removed.

The middle portion 88 also forms the grip surface 89 over its entire surface, preferably with a rubber-like or latex-like coating 44 being provided. This coating 44 can improve the haptic feeling of the stimulation head 4.

Furthermore, the middle portion 88 is formed over large parts of the housing 8 in the longitudinal direction. In synergy with the waisted design of the housing 8, this leads to an ergonomic handling of the housing 8, as the housing 8 comes to rest in the slim area in the middle at or on the hand when the housing 8 is guided like a writing instrument. In addition, the thumb and index finger rest against the front thickening of the housing 8 in this grip position, which is more ergonomic.

In addition, the stimulation device 1 has the thickening or knob-like cross-sectional enlargement at the rear end 91. This has the advantage that the stimulation device 1 has a kind of “knob” or “button” at the rear end 91, at which the stimulation device 1 can be held comfortably in a closed hand (for example in a first position), which is also an ergonomic hand position.

Alternatively, the thickening of the housing 8 at the rear end 91 may have a larger maximum radius in the transverse direction, similarly to the front thickening.

The cap 85 is configured analogously to the first embodiment, and fits the housing shape of the housing 8 of the third embodiment accordingly.

The angle of intersection between the alignment axis 81 and the longitudinal axis 80 can preferably be an acute angle. Preferably, this angle is about 3 to 12 degrees, which, according to experiments, has generally proven to be a pleasant angle range for the user for handling.

With reference to FIG. 15 a) a side view of a stimulation device according to the invention is explained in greater detail, and with reference to FIG. 15 b) a view of the stimulation device according to the invention of FIG. 15 a) from behind is explained in greater detail.

FIG. 15 a) shows a housing 8 which is triangular in cross-section and elongate. Preferably the outer shape is configured with the same thickness in the cross-sectional direction to save material and weight. On the one hand, this allows a very light and compact housing to be realized, while on the other hand a triangular housing of the same thickness fits well with the anatomy of holding the housing 8 with the thumb and index finger like a writing instrument, and is therefore ergonomic.

The on/off switch 74 is again recessed in the rear end 91 of housing 8, so that the stimulation device 1 can be placed upright on a table, for example, via the flat rear end 91.

The grip surfaces 89 (one of which is not shown in detail because it is concealed on the opposite side of the triangle of even thickness) are elongate oval, and are arranged in such a way that they represent the contact surface of the fingers on the housing 8 when the housing 8 is guided in the manner of a writing instrument. The two grip surfaces 89 are thus asymmetrically arranged. The grip surface 89 shown in FIG. 10 a) is intended for the thumb of a left-handed person. The grip surface (not shown in greater detail) would be arranged in an elongate oval shape on the other side of the triangle, more in the direction of the longitudinal axis 80 of the housing 8, corresponding to the (imaginary) position of an index finger. In this way, the grip surfaces can be adapted to the anatomy of the hand and the fingers of the user (particularly preferably according to whether she is right- or left-handed).

In addition, the grip surfaces 89 can also be configured as trough-shaped recesses in the middle portion 88. Alternatively, the grip surfaces 89 can have corresponding rubber coatings to improve the gripping of the device.

The cap 85 according to the invention is configured analogously to the first embodiment, and fits the housing shape of the housing 8 of the third embodiment accordingly and continues the housing shape in the direction of the longitudinal axis 80.

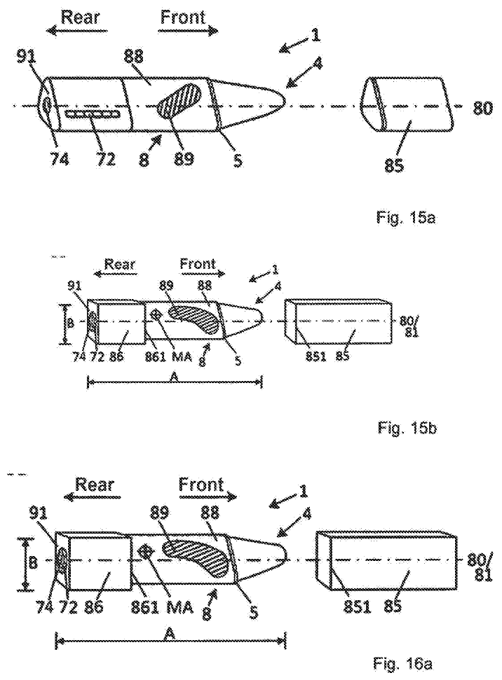

With reference to FIG. 16 a), a side view of a fifth embodiment of a stimulation device according to the invention, and with reference to FIG. 16 b) a view from the rear of the stimulation device according to the invention of FIG. 16 a) is explained in greater detail.

In the fifth embodiment, the outer contour of the cross-section changes at the transition 5 between the middle portion 88 and a rear portion 86. The middle portion 88 is preferably triangular in cross-section with rounded corners or edges (in particular of the same thickness; alternatively, the middle portion 88 of this configuration may also be round or oval). The rear portion 86 is preferably rectangular or square in cross-section (alternatively, it may be quadrangular or spherical; the latter results in the formation of a spherical or button-shaped retaining knob at the rear end 91 of the stimulation device 1). Preferably, those parts that are heavy or have a high weight are arranged in the rear portion 86 of the housing 8, for example the battery 76. This allows the center of mass MA of the housing 8 of the stimulation device to be placed further back in the direction of the rear end 91, which leads to better handling.

The ratio of length A to width B (which is equal to height C) of the housing 8 preferably is >3.5 (three point five), especially ≥3.9 (three point nine). Due to this elongate design, the housing 8 is easier to handle and more ergonomic.

The indicator 72 is located at the rear end 91 of the housing 8 in the form of an LED display surrounding the on/off switch 74. The user thus intuitively associates the display of the power-on status with the associated on/off switch 74 and vice versa.

Thus, the fifth embodiment is preferably characterized in that the outer contour of the housing 8 changes from the middle portion 88 to the rear portion 86. In other words, this aspect is preferably characterized in that the middle portion 88 has a different outer contour as compared to the rear portion 86.

Compared to the caps 85 of the first to fourth embodiments, the cap 85 of the fifth embodiment is longer. Thus, when the cap 85 of the fifth embodiment is fitted on the housing 8, not only the front end 90 is covered with the wall 41, but also the middle portion 88. Thus, the stop 851 of the cap 85 strikes the stop 861 of the rear portion 86 when the cap 85 is fitted on the housing 8. When the cap 85 is fully inserted, the stimulation device 1 has a uniform, elongate cuboidal appearance, which makes it impossible to see at first glance what the purpose is of the stimulation device 1 contained therein. In this respect, with the present discreet, light and compact design of the stimulation device 1, the stimulation device 1 can, for example, be carried discreetly and hygienically in a handbag.

In this aspect of the third embodiment, the alignment axis 81 can preferably coincide with the longitudinal axis 80, i.e. these are preferably arranged coaxially to each other.

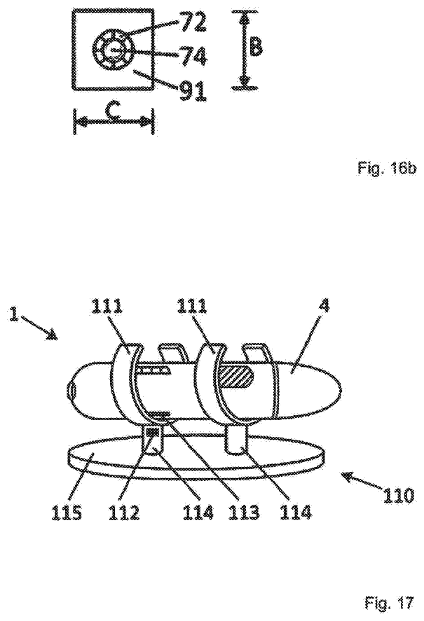

FIG. 17 shows a system with one of the embodiments according to the invention of the stimulation device 1. It is noted that the system presented below can also be combined with the first or second embodiment. For example, a holder 110 has at least two fork-shaped holding arms 111, in which the stimulation device 1 is placed. The holding arms 111 are connected via holding legs 114 to a holder foot 115, which is preferably smooth and flat. In at least one of the holding legs 114 there is a charging coil or inductor 112 on the holding side. Correspondingly, the stimulation device 1 according to the invention has a charging coil or inductor 113 on the stimulation device side. If the stimulation device 1 is placed in the holding arms 111, a (known) inductive coupling between the stimulation device and an electronic power device (not shown in detail) can take place via the (preferably paired) coils. In this way, a battery 76 of the stimulation device 1 can be charged in wired fashion or wirelessly without the need for a socket or a connection to or in the housing 8. This simplifies, for example, a waterproof design of the housing 8.

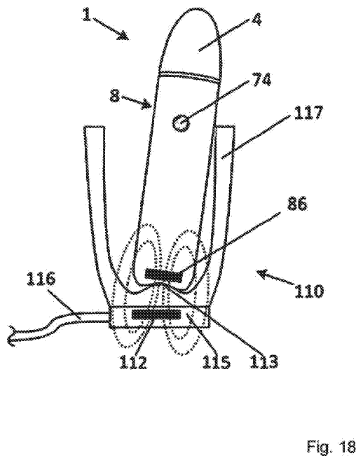

FIG. 18 shows an alternative system with a holder 110 for charging the stimulation device 1 according to the invention. Here, the charging coil or inductor 113 on the stimulation device side can be located advantageously in the rear end 91 of the stimulation device 1. This facilitates a suitable weight distribution and adjustment of the center of mass MA of the stimulation device 1. In addition, (favorable) coils are preferably circular in shape, whereby they can be accommodated in the housing 8 advantageously compactly with the center axis of the coil in a coaxial (or alternatively parallel) orientation with respect to the longitudinal axis 80. The holder 110 is a cup-shaped device, for example a water glass, into which the pen-shaped stimulation device 1 is simply inserted. This has the advantage that the holder 110 can be easily cleaned. The plate-like or planar base 115 on which the holder 110 is placed houses the charging coil or inductor 112 on the holder side. If the stimulation device 1 is placed in the holder 110, an inductive coupling between the stimulation device 1 and an electronic power device (not shown in detail) can take place via the (preferably paired) coils above. Accordingly, the battery 76 of the simulation device 1 can also be supplied and charged with energy in wired fashion or wirelessly with this holder 110.

In addition to the explained embodiments, the invention allows further design principles.

Although the stimulation head 4 is shown with a smooth wall 41, it may also have protrusions, nubs or also indentations.

The features of the different aspects and embodiments can be combined arbitrarily with each other as long as this is technically possible. For example, the moving coil assembly 60 of FIG. 6 can be used with the third embodiment.

It will be appreciated that the sensor device 78 and the control device 7 can be formed as separate circuits or as one common circuit. If they are configured as a common circuit, they may, for example, be located on a common circuit board. In addition, the sensor device 78 and the control device 7 may be parts of a software program which are run in a computing unit.

Furthermore, the described heating unit, the proximity sensor and also the control patterns with all their associated features can also be provided in a stimulation device without the described linear drive device with an electromagnetic linear actuator which has at least one nonmoving permanent magnet and at least one conductor movably arranged in the magnetic field of the permanent magnet, the movably arranged conductor being movable in accordance with the actuation of the control device for generating vibrations.

For example, the described heating unit, the proximity sensor and also the control patterns with all their associated features can also be used in a stimulation device according to the invention which has a moving permanent magnet and a fixed coil.

Thus, according to an alternative of the invention, the drive device may have a (very easy to move, for example less than 10 grams) permanent magnet, and a fixedly installed coil of the solenoid type, with other further developments of the invention described above possibly being combined with this drive device.

Also, the described heating unit, proximity sensor and also the control patterns can be intended as a further development of the prior art.

In addition, the sensor device 783 can have signal preprocessing or signal conditioning. For example, threshold values or at least one measuring range may be provided in the sensor device 783, or the raw signals of the sensor device 783 may also be processed in the control device 7.

Also, the openings 68c of FIG. 6 e) are shown in a kidney shape, these openings 68c being adapted to the shape of the extensions 63a of the coil carrier 63. Thus, the coil carrier 63 can be provided preferably circularly in cross-section, the extensions 63a then being able to be shaped in accordance with a circular portion, which in turn results in the kidney shape of the openings 68c. For example, the coil carrier 63 can be manufactured from a tube during production, with the extensions 63a being formed by removing portions of the tube. However, the shape of the openings 68c and the extensions 63a is not limited to these specific shapes. For example, the openings 68c may be circular, and the extensions 63a may be pin-shaped.

Furthermore, the measures to increase the mechanical robustness of the moving coil assembly 60 of FIG. 6 a) to 6 e) can also be used with other stimulation heads 4 or other shapes, layered arrangements or other forms of a head element 45. This is shown, for example, in FIGS. 3, 4 and 5. In other words, the various measures to increase mechanical robustness (for example a second suspension) can in principle also be used with other moving coil assemblies 60, for example the feature of a further suspension 65a, 65b can also be combined with other stimulation heads 4 (especially that of FIG. 4).

Furthermore, the moving coil 62 can be provided overhanging or underhanging or otherwise dimensioned as long as it can vibrate in the magnetic field of the moving coil assembly 60 when excited. The moving coil 62 can also be single wound, double wound or have different winding heights as long as it can vibrate in the magnetic field of the moving coil assembly 60 when excited.

Furthermore, in accordance with a development of the described teaching, the moving coil assembly 60 with the stimulation head 4 can be dimensioned in such a way that the resonance frequency of the arrangement is at approximately 80 Hz (+/−5 Hz), with the 6 dB limit of the corresponding frequency response of the arrangement in the range between 60 Hz to 100 Hz preferably not being undershot, thus providing an optimum working range within this range. According to experiments by the inventors, this frequency range has proven to be particularly stimulating for the clitoris.

For example, the total mass of the at least one suspension 65, 65a, 65b (centering spider), the moving coil 62, the stimulation head 4, as well as the magnetic flux density of the moving coil assembly 60 and the spring force of the suspension(s) may be dimensioned such that the resonant frequency of the assembly is about 80 Hz (+/−5 Hz).

The measuring range can also have a different shape than the one shown in the drawings. For example, it can be ring-shaped or conical.

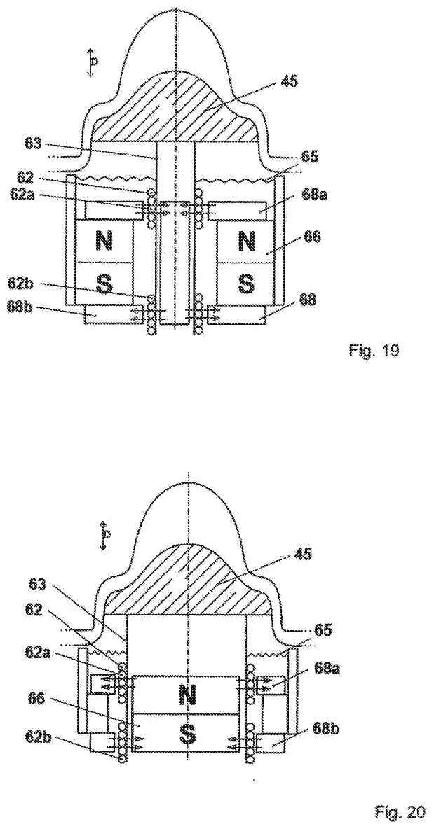

FIG. 19 to 25 show further embodiments of an arrangement for a stimulation device 1 or arrangements for the drive unit or device 6. In each case, coil elements of an electromagnetic linear drive are arranged so that they can be moved or displaced in a stationary permanent 10 magnetic field. Like reference signs as compared to the previous drawings are used for like features.

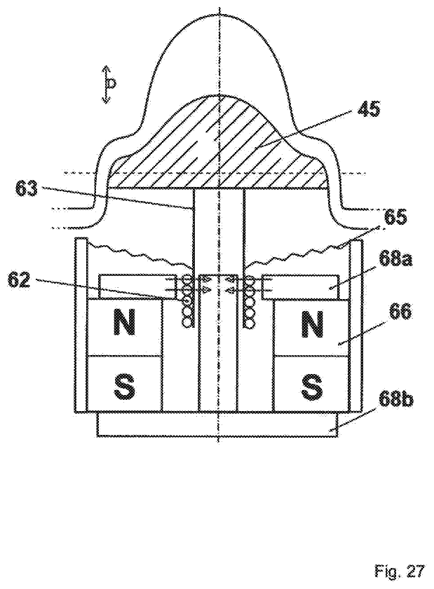

In the embodiments in FIG. 19 to 25, the suspension or holder 65, which acts as a positioning or centering device for the carrier 63 with the (voice) coil 62 and is optionally formed with a membrane, is shown in a neutral starting state in which no deflection has occurred. In contrast to this, FIGS. 26 and 27 show an embodiment in which the carrier 63 with the moving coil 62 moves from the neutral starting or zero position (see FIG. 19 to 25) downwards into the stationary permanent magnetic field. Together with the carrier 63, the displaceable head element 45 is displaced downwards. During operation the carrier 63 with the moving coil 2 and the displaceable head element 45 then vibrate around the neutral rest position, starting from the deflected starting position shown in FIGS. 26 and 27. In other embodiments, in particular the examples shown in FIG. 19 to 25, the carrier 63 is vibrated around this neutral starting position starting from the neutral rest position shown in FIG. 19 to 25.

The embodiments in FIGS. 26 and 27 make it possible, in particular, to apply an electrical current of non-changing polarity to the moving coil 62 for operation. A current of alternating polarity is, however, provided for in other embodiments, for example in one or more of the embodiments shown in FIG. 19 to 25. Embodiments other than those shown in FIGS. 26 and 27 can also be operated around a deflected position different from the neutral rest or starting position.

In the embodiments in FIG. 19 to 22 the moving coil 62 has an upper moving coil 62a and a lower moving coil 62b with separate coil windings. In the examples in FIGS. 19 and 20, the upper and lower moving coil 62a, 62b are each arranged opposite pole plates 68a, 68b, with the permanent magnets 66 arranged outside (FIG. 19) or inside (FIG. 20) relative to the moving coil 62. The internal design supports the formation of an optimized magnetic induction.

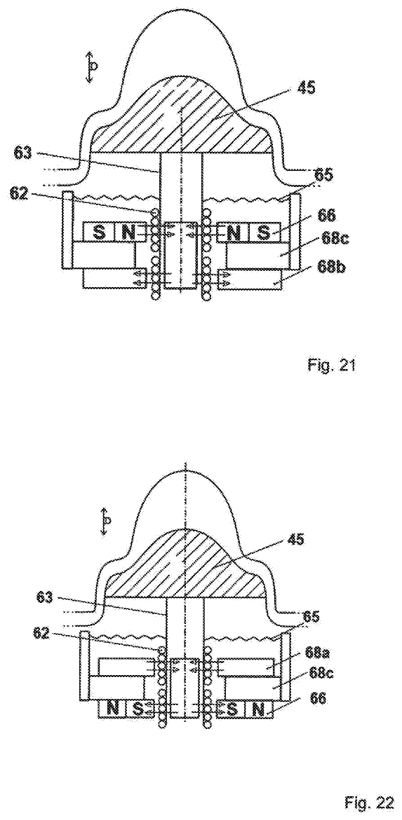

Also, in the examples in FIGS. 21 and 22, the permanent magnets 66 are arranged outside relative to the moving coil 62. The arrangement of the permanent magnets 66 shown there, which, as compared to the embodiment in FIG. 19, are provided instead of the upper pole cap 68a or the lower pole cap 68b, supports a flat design.

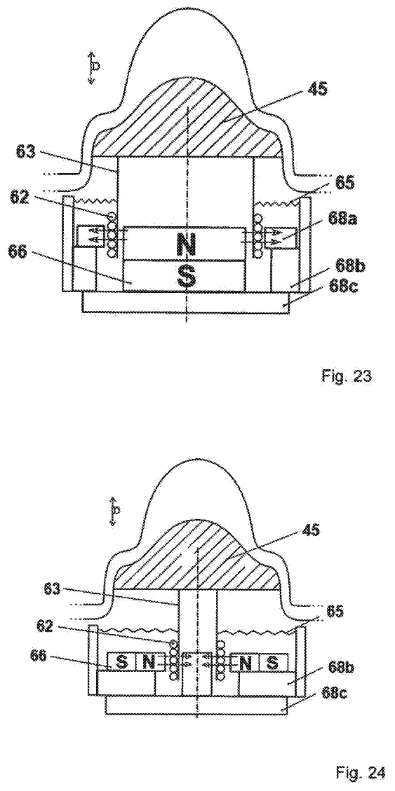

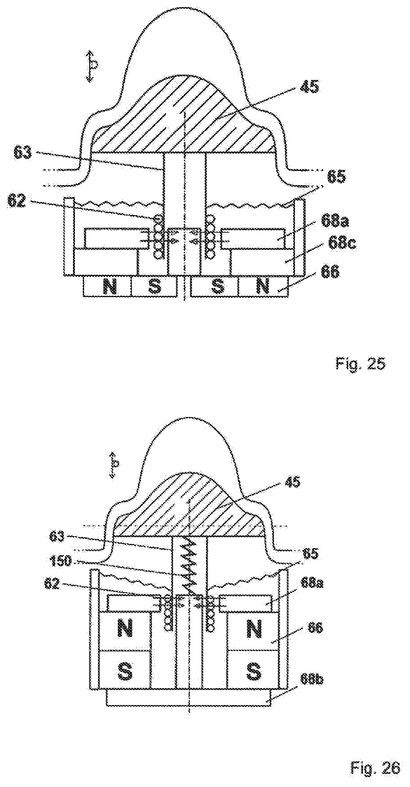

The embodiments in FIG. 23 to 25 use a one-piece coil 62 as compared to the embodiments in FIG. 19 to 22, however, the permanent magnets 66 may also be arranged internally and externally relative to the coil 62, as shown according to FIGS. 23 and 24. In the embodiment in FIG. 25, the permanent magnets 66 are arranged below the moving coil 62.

In the example in FIG. 19, upper and lower pole caps 9a, 9b are provided, which are arranged above and below the permanent magnets 66. In the embodiment in FIG. 20, the upper and lower pole caps 68a, 68b are arranged above and below a central pole cap 68c and in contact therewith.

In the embodiments in FIGS. 26 and 27, the permanent magnets 66 are arranged between the upper or front pole plate 68a and the lower or rear pole plate 68b and in contact therewith. According to FIG. 26 a spring 150 is provided, which provides a spring pretension against the shown deflected position of the carrier 63 with the moving coil 62. FIG. 27 shows an alternative embodiment in which the spring 150 is omitted. A pretension can be provided here by means of the suspension/holder 65.

The features disclosed in the above description, the claims and drawing may be relevant either individually or in any combination for the realization of the various embodiments.

### LIST OF REFERENCE SIGNS

1 Stimulation device
2 Remote control device
3 Vibrating element
4, 4a Stimulation head
5 Transition
6 Drive device
7 Control device
8 Housing
8a Holder/fastening of the housing 8 for the suspension 65, 65a
8b Receptacle of the housing 8 for the moving coil assembly 60
9 Lighting system
10 Outer layer
11 Body part or erogenous zone
12 Clitoris
31 Engagement
41 Wall
42 Front portion of the stimulation head
43 Rear portion of the stimulation head
44 Coating
45 Head element
46 Exchangeable stimulation head
60 Moving coil assembly
61 Pole core
61a Impedance control ring
62 Moving coil
63 Moving coil carrier
63a Extension of the moving coil carrier
64 Air gap
65 Suspension, preferably centering membrane
65a Further suspension
65b Yet another suspension
66 Permanent magnet
67 Supply line
68a Front pole plate
68b Rear pole plate
68c At least one opening in the rear pole plate 68b
69a Front stop element
69b Rear stop element
69c Stop element (for both directions)
69d Bearing or guide
71 Operating element
72 Indicator
73 Power supply
74 On/off switch
75 Socket for power supply
751 Socket closure
76 Battery
77 Control board
78 Antenna
781 Measuring range or measuring window
782 Measuring electrode
783 Sensor device
79 Heating element
80 Longitudinal axis
801 Engagement or fastening
802 Adhesive bonding
81, 81a Alignment axis
82 Center axis of the motor axis
85 Cap
851 Stop edge of the cap
852 Logo area
86 Rear portion
861 Stop edge of the housing
862 Snap-in catch
863 Recessed or set-back end face
88 Middle portion
89 Grip surfaces
90 Front end
91 Rear end
110 Holder
111 Holding arms
112 Charging coil on the holder
113 Charging coil on the stimulation device
114 Holding legs
115 Holder foot
116 Power supply cable
117 Holder cup
140 Extension
141 Connection
142 Vibration device
150 Spring
MA Center of mass

The status of the claims:

1. A stimulation device for a clitoris, the stimulation device comprising:
a stimulation head to contact the clitoris;
a linear drive device coupled to the stimulation head, the linear drive device configured to cause the stimulation head to vibrate;
a control device configured to control the linear drive device;
a battery to supply power to the control device; and
a housing, the control device and the battery disposed in the housing.

2. The stimulation device of claim 1, wherein the linear drive device includes an electromagnetic linear actuator, the electromagnetic linear actuator including at least one stationary permanent magnet and at least one conductor movably arranged in a magnetic field of the permanent magnet the movably arranged conductor being movable in response to actuation of the control device (7) to generate vibrations.

3. The stimulation device of claim 1, wherein vibration amplitude of the stimulation head is to be controlled by the control device independently of and vibration frequency of the stimulation head.

4. The stimulation device of claim 1, wherein the linear drive device is configured to generate multi-frequency vibrations.

5. The stimulation device of claim 1, wherein the linear drive device includes a moving coil assembly including a moving coil (62) and a vibrating element (3).

6. The stimulation device claim 1, wherein the linear drive device is configured to generate a maximum vibration amplitude of 0.1 mm.

7. The stimulation device of claim 1, wherein the linear drive device is configured to cause amplitude-modulated and/or frequency-modulated vibrations of the stimulation head.

8. The stimulation device of claim 5, wherein
the linear drive device includes a membrane, the moving coil suspended via the membrane,
the moving coil to move in a magnetic field of a permanent magnet of the moving coil assembly in response to feeding a control current from the control device into the moving coil.

9. The stimulation device of claim 1, further including at least one stop element to protect the linear drive device against damage.

10. The stimulation device of claim 5, wherein the stimulation head is exchangeably coupled to the vibrating element of the moving coil assembly.

11. The stimulation device of claim 1, wherein
the control device includes a signal generator configured to generate substantially rectangular, triangular or sawtooth-shaped vibrations;
the signal generator configured to at least one of (a) generate the triangular vibrations in a frequency range from approximately 20 to 170 Hz; or
the signal generator is configured to (b) generate the vibrations in a band over a continuous frequency range of at least 20 Hz.

12. The stimulation device of claim 8, wherein the membrane is to seal the moving coil from an external environment with respect to of the stimulation device.

13. The stimulation device of claim 1, further including a sensor device to:
detect one or more of an approach of the stimulation device towards the clitoris (12) or contact of the stimulation device with the clitoris; and
output an activation signal to the control device when the one or more of the approach or the contact is detected, the control device configured to activate the linear drive device in response to the activation signal.

14. The stimulation device of claim 13, wherein the sensor device is configured to generate and detect an electromagnetic field, the electromagnetic field being provided in the vicinity of the stimulation head.

15. The stimulation device of claim 5, wherein the housing and the moving coil assembly are waterproof.

16. The stimulation device of claim 1, wherein
the control device includes a random generator to generate a substantially random control pattern, the linear drive device to be controlled by the control device to provide random stimulation patterns corresponding to the vibrations of the stimulation head.

17. The stimulation device of claim 1, further including an extension in the form of a dildo for insertion into a vagina.

18. The stimulation device of claim 1, wherein the housing includes an outer layer including silicone, rubber or a polymer, the outer layer at least partially enclosing the housing.

19. The stimulation device of claim 1, further including a heating element for heating the stimulation head.

20. The stimulation device of claim 1, wherein
the stimulation head is removably coupled to the linear drive device.

21. The stimulation device of claim 1, further including a detection device for detecting an amplitude of vibrations of the stimulation head.

22. The stimulation device of claim 21, wherein the detection device is communicatively coupled to the control device, the control device to respond to a detection signal from the detection device to at least partially compensate for damping of the vibration amplitude of the stimulation head when the stimulation head is placed on skin.

23. (canceled)

24. A method comprising:
detecting, via a sensor device of a stimulation device, one or more of: (a) whether a stimulation head of the stimulation device is approaching a clitoris of a user or (b) whether the stimulation head is in contact with the clitoris;
when the one or more the approach or the contact is detected by the sensor device, generating, via the sensor device, an activation signal and outputting the activation signal to a control device of the stimulation device;
activating a drive device of the stimulation device in response to receipt of the activation signal by the control device; and
generating vibrations of the stimulation head via the drive device of to stimulate the clitoris (12).

25. The method of claim 24, wherein generating the vibrations includes generating substantially rectangular or triangular or sawtooth-shaped vibrations.

26. The method of claim 24, wherein generating the vibrations includes generating vibrations having at least two simultaneously occurring vibration frequencies.

27. The stimulation device of claim 14, wherein the electromagnetic field is to be provided in front of the stimulation head.

28. The stimulation device of claim 1, wherein the control device provides at least one predefined control pattern, the linear drive device to be controlled by the control device such that the vibrations of the stimulation head provide a corresponding predefined stimulation pattern.

29. The stimulation device of claim 1, wherein stimulation device is a hand-held device.

30. The stimulation device of claim 1, wherein the linear drive device is an electromagnetic linear transducer free from moving permanent magnets.
